(19) United States
(12) Patent Application Publication
(10) Pub. No.: US 2013/0098646 A1
(43) Pub. Date: Apr. 25, 2013

(54) Power Tool and Battery Pack for Use in the Power Tool

(71) Applicants: Kazuhiko Funabashi, Ibaraki (JP); Nobuhiro Takano, Ibaraki (JP); Yukihiro Shima, Ibaraki (JP)

(72) Inventors: Kazuhiko Funabashi, Ibaraki (JP); Nobuhiro Takano, Ibaraki (JP); Yukihiro Shima, Ibaraki (JP)

(73) Assignee: HITACHI KOKI CO., LTD., Tokyo (JP)

(21) Appl. No.: 13/805,299

(22) PCT Filed: Aug. 31, 2011
(86) PCT No.: PCT/JP2011/070309

§ 371 Date: Dec. 18, 2012

(30) Foreign Application Priority Data
Aug. 31, 2010 (JP) 2010-195200

(51) Int. Cl. B25F 5/00; H01M 10/42; B23Q 17/00

(52) U.S. Cl. CPC B25F 5/00; B23Q 17/007; H01M 10/425
USPC 173/2; 173/20; 429/61

(57) ABSTRACT

A power tool includes: a battery cell group including a plurality of secondary battery cells; a motor to which an electric power is supplied from the battery cell group through a switching element and a trigger switch; a current detector detecting a current value flowing in a current path; and a controller configured to receive a detection signal from the current detector and controls on/off operation of the switching element. If the current detector detects that the current value flowing in the battery cell group continuously exceeds a given value for a first time period, the controller conducts one of alarm display and alarm control for allowing an operator to recognize that a high load operation continues. If the current value continuously exceeds the given value for a second time period longer than the first time period, the controller turns off the switching element to interrupt the current path.

### TECHNICAL FIELD

The present invention relates to a cordless power tool using a lithium-ion battery, and more particularly to a cordless power tool having a protection circuit that protects against an overcurrent state in which a relatively large current lasts seconds to minutes, and a battery pack for use in the power tool.

### BACKGROUND ART

Power tools such as electric screwdrivers, electric drills, or impact tools generally transmit a power of a motor to a tip tool after a rotating power from the motor is decelerated by a deceleration mechanism. As a power supply of the motor, a commercial AC power supply has been used up to now. However, in recent years, the cordless power tools each using a secondary battery represented by a nickel hydride battery or a lithium-ion battery as a power supply have been frequently used. In particular, lithium-ion secondary batteries represented by the lithium-ion battery and a lithium-ion polymer battery can reduce the number of battery cells required because a nominal voltage is large, resulting in such an advantage that the power tool can be reduced in weight and size. In the present specification, the lithium-ion secondary battery means a secondary battery that is one type of non-aqueous electrolyte secondary batteries in which lithium ions in electrolyte bear electric conduction. The lithium-ion battery generally uses lithium cobalt oxide for a positive electrode, graphite for a negative electrode, and organic electrolyte as electrolyte.

The nominal voltage of the lithium-ion secondary battery is high, for example, 3.6 V, and a voltage corresponding to three nickel hydride batteries is obtained from the lithium-ion secondary battery. Therefore, the lithium-ion secondary battery is advantageous in that the number of battery cells can be remarkably reduced as compared with the nickel hydrogen battery when the lithium ion secondary battery is used as a power supply of the power tool. On the other hand, there is a risk that when the lithium ion secondary battery is overcharged or overdischarged, or an excessive current is allowed to flow therein, a cycle life is remarkably deteriorated.

In order to prevent overcurrent, the present applicants have proposed, in JP-A-2006-281404, a battery pack having a protection circuit that can allow an instantaneous overcurrent flowing at the time of starting the motor and interrupt an overcurrent during rocking of the motor, which occurs at the time of using the power tool. Also, the present applicants have proposed, in JP-A-2010-131749, that a required number of interrupting units for interrupting a flow of current when an overcurrent or overdischarge occurs are disposed at the power tool side.

### SUMMARY

In the power tool, it is important to protect the motor from the overcurrent. On the other hand, it is found that it is also important to prevent the battery from being deteriorated by allowing a given large current (or medium current) to continue to flow for a given time period or more. For example, in a circuit including a motor and a battery illustrated in FIG. 15, when a DC voltage is applied to a DC motor M from a battery V that is a DC power supply through a switch S, a current Ia represented by the following Expression (1) flows in the DC motor and the switch S immediately after the switch S is closed, that is, at the time of start.

Ia=(V−E)/Ra (1)

where V is a voltage of the DC power supply V, Ra is a resistance value of an armature winding of the DC motor M, and E is a back electromotive force of the DC motor.

Because a rotor is at rest at the time of starting the DC motor M, the back electromotive force E becomes 0, thereby making it difficult to prevent an excessive current from flowing in a very short time period. On the other hand, in the power tool such as an electric driver or an electric drill, the tip tool may be cut or bitten into a workpiece. In this case, the DC motor M may be temporarily locked. When the motor is locked, the back electromotive force E of the DC motor M becomes 0, and therefore an excessive current flows in the circuit.

Also, in the cordless power tool such as a circular saw, a hammer drill, or a jigsaw, although the motor is hardly locked, a high load is exerted on the motor depending on the degree of pressing the power tool by an operator, and the rpm of the motor is decreased to reduce the back electromotive force E. As a result, there is a risk that a considerable current continues to flow in the motor. When the considerable current thus continues to flow in the motor, a large power continues to be discharged from the battery, resulting in a risk that the cycle life is deteriorated due to the overdischarge of the battery and the large current for a long time period.

The present invention has been made in the above circumstances, and therefore an object of the present invention is to provide a power tool using a second battery such as a lithium-ion battery as a power supply, including an overcurrent protection circuit that interrupts continuance of the discharge of the large current flowing in use for a given time period or more.

Another object of the present invention is to mount an overcurrent protection circuit for a battery pack in the battery pack detachably attached to the power tool.

Still another object of the present invention is to provide a power tool that allows an operator to recognize an overcurrent state before the overcurrent state continues to interrupt current supply.

Typical features of the present invention disclosed in the present invention will be described below.

(1) A power tool comprising:

a battery cell group including a plurality of secondary battery cells;

a switching element;

a trigger switch;

a motor to which an electric power is supplied from the battery cell group through the switching element and the trigger switch;

a current detector configured to detect a current value flowing in a current path that passes through the battery cell group, the switching element, and the motor; and

a controller configured to receive a detection signal from the current detector and controls on/off operation of the switching element,

wherein if the current detector detects that the current value flowing in the battery cell group continuously exceeds a given value for a first time period, the controller conducts one of alarm display and alarm control for allowing an operator to recognize that a high load operation continues, and

wherein if the current value continuously exceeds the given value for a second time period longer than the first time period, the controller turns off the switching element to interrupt the current path.

(2) The power tool according to (1), wherein

the controller includes a microcomputer having a timer, and

the microcomputer counts a duration of a state in which the detected current value exceeds the given value by using a signal from the current detector and the timer.

(3) The power tool according to (1), wherein

the controller includes a dedicated integrated circuit having a built-in or external timer, and

the integrated circuit counts a duration of a state in which the detected current value exceeds the given value by using a signal from the current detector and the timer.

(4) The power tool according to (2) or (3), wherein the battery cell group is detachably attached to a main body of the power tool as a battery pack stored in a housing.
(5) The power tool according to (4), wherein the controller and the switching element are disposed within the battery pack.
(6)

The power tool according to (4), wherein the controller and the switching element are disposed on a main body in which the trigger switch and the motor are disposed.

(7) The power tool according to (6), wherein

the controller is disposed within the battery pack,

the switching element is disposed on the main body side, and

the battery pack includes a connection terminal that outputs a control signal of the switching element to the main body.

(8) The power tool according to any one of (1) to (7), wherein

the switching element includes a field effect transistor, and

under the alarm control, the controller repeats the on/off operation of the switching element by a plurality of times at short time intervals when the first time period is elapsed.

(9) A power tool comprising:

a battery cell group including a plurality of secondary battery cells;

a switching element;

a trigger switch;

a motor to which an electric power is supplied from the battery cell group through the switching element and the trigger switch;

a current detector configured to detect a current value flowing in a current path that passes through the battery cell group, the switching element, and the motor; and

a controller configured to turn off the switching element if the current detector detects an excessive current for a given time period or more,

wherein the controller executes a notice control for notifying an operator that the switching element is turned off before the switching element is turned off.

(10) The power tool according to (9), wherein the controller turns off the switching element if the excessive current is not eliminated until the given time period is elapsed since the notice control is executed.
(11) The power tool according to (9), wherein the notice control repeats the on/off operation of the switching element by a plurality of times at short time intervals.
(12) A battery pack comprising:

a battery cell group including a plurality of secondary battery cells;

a control circuit configured to monitor a discharge current from the battery cell group;

a connection terminal configured to be connected to a battery-driven-device; and

a switching element configured to interrupt a discharge path from the secondary battery cells to the connection terminal,

wherein the control circuit interrupts the switching element if the discharge current from the secondary battery cells exceeds an allowable discharge maximum value, and

wherein the control circuit interrupts the switching element if the discharge current from the secondary battery cells continuously exceeds a reference current value lower than the allowable discharge maximum value and falls below the allowable discharge maximum value for a first time period.

(13) The battery pack according to (12), wherein

the switching element includes a semiconductor switching element, and

the control circuit includes a microcomputer having a timer.

(14) The battery pack according to (13), wherein

the switching element includes a semiconductor switching element, and

the control circuit includes a dedicated integrated circuit having a built-in or external timer.

(15) A power tool comprising:

at least one secondary battery cell;

a switching element;

a trigger switch;

a motor to which an electric power is supplied from the battery cell through the switching element and the trigger switch;

a current detector configured to detect a current value flowing in a current path that passes through the battery cell, the switching element, and the motor; and

a controller configured to receive a detection signal from the current detector and controls on/off operation of the switching element,

wherein if the current detector detects that the current value flowing in the battery cell continuously exceeds a given value for a first time period, the controller conducts one of alarm display and alarm control for allowing an operator to recognize that a high load operation continues, and

wherein if the current value continuously exceeds the given value for a second time period longer than the first time period, the controller turns off the switching element to interrupt the current path.

(16) A power tool comprising:

at least one secondary battery cell;

a switching element;

a trigger switch;

a motor to which an electric power is supplied from the battery cell through the switching element and the trigger switch;

a current detector configured to detect a current value flowing in a current path that passes through the battery cell, the switching element, and the motor; and

a controller configured to turn off the switching element if the current detector detects an excessive current for a given time period or more,

wherein the controller executes a notice control for notifying an operator that the switching element is turned off before the switching element is turned off.

(17) A battery pack comprising:

at least one secondary battery cell;

a control circuit configured to monitor a discharge current from the battery cell;

a connection terminal configured to be connected to a battery-driven-device; and

a switching element configured to interrupt a discharge path from the secondary battery to the connection terminal,

wherein the control circuit interrupts the switching element if the discharge current from the secondary battery exceeds an allowable discharge maximum value, and

wherein the control circuit interrupts the switching element if the discharge current from the secondary battery continuously exceeds a reference current value lower than the allowable discharge maximum value and falls below the allowable discharge maximum value for a first time period.

According to the first aspect of the present invention, the switching element is forcedly turned off when the second time period is elapsed while the current value flowing in the battery cell group remains the given value or more. Therefore, even if the large current or the medium current which is not interrupted by only the magnitude of the current value continues for the given time period or more, the current path can be effectively interrupted. Further, when the current value flowing in the battery cell group continues the given value or more for the first time period, the alarm display or the alarm control is conducted for allowing the operator to recognize that the high-load operation is continued. As a result, since the current interruption unexpected by the operator is avoided, the convenient power tool can be realized.

According to the second aspect of the present invention, since the duration of the state in which the detected current value exceeds the given value is counted by the microcomputer, the continuous discharge state of the large current can be easily detected by execution of the program.

According to the third aspect of the present invention, since the controller is realized by a dedicated integrated circuit having the built-in or external timer, the continuous discharge state of the large current can be detected by using the integrated circuit.

According to the fourth aspect of the present invention, since the battery cell group is detachably attached to the main body of the power tool as the battery pack stored in the housing, the battery pack can be easily replaced with another one, and set on the dedicated charger so as to be easily charged.

According to the fifth aspect of the present invention, since the controller and the switching element are disposed within the battery pack, the continuous discharge state of the large current can be effectively prevented by only the battery pack despite the configuration of the power tool side.

According to the sixth aspect of the present invention, since the controller and the switching element are disposed on the main body side of the power tool, the continuous discharge state of the large current can be prevented even if any type of battery pack is loaded in the power tool.

According to the seventh aspect of the present invention, since the controller is disposed within the battery pack, and the switching element is disposed on the main body side of the power tool, the configuration of the battery pack side can be simplified, and the costs of the battery pack can be reduced. Also, since the battery pack is provided with the connection terminal that outputs the control signal of the switching element to the main body side of the power tool, the current path can be interrupted from the battery pack side.

According to the eighth aspect of the present invention, since the switching element is configured by the field effect transistor, and under the alarm control, the controller repeats the on/off operation of the switching element by the plurality of times at short time intervals when the first time period is elapsed, the alarm operation can be easily realized by using the element that interrupts the current path.

According to the ninth aspect of the present invention, there are provided the current detector that detects the current value flowing in the current path, and the controller that turns off the switching element when the current detector detects the excessive current for the given time period or more, and the controller executes the notice control for notifying the operator that the switching element is turned off before the switching element is turned off. With the above configuration, there can be realized the useful power tool which can prevent the motor from being stopped without any notice.

According to the tenth aspect of the present invention, the controller turns off the switching element when the excessive current is not eliminated until the given time period is elapsed since the notice control is executed. With the above configuration, if the excessive current is eliminated, the operation can be continued as it is. Also, if there is the notice control, the operator can change the operating state of the power tool, for example, implement countermeasures to avoid the large-current discharge state by weakening the pushing load.

According to the eleventh aspect of the present invention, since the notice control repeats the on/off operation of the switching element by a plurality of times at the short time intervals, the notice control can be easily realized by using the existing element without adding a new electronic element or member, and an increase in the manufacturing costs can be minimized.

According to the twelfth aspect of the present invention, since the control circuit is disposed in the battery pack, the discharge path can be interrupted instantaneously when the discharge current from the battery pack exceeds the allowable discharge maximum value. Also, the switching element is interrupted when the discharge current from the secondary battery cells exceeds the allowable discharge maximum value, and the switching element is interrupted when the discharge current from the secondary battery cell continues the reference current value of the allowable discharge maximum value or lower for the first time period. Therefore, the discharge state can be forcedly interrupted when the discharge current continues the given value or more for the given time period or more by the battery pack alone.

According to the thirteenth aspect of the present invention, since the switching element is configured by the semiconductor switching element, and the control circuit is configured by the microcomputer having the timer, the protection circuit of the excessive current can be realized with a simple circuit configuration.

According to the fourteenth aspect of the present invention, since the switching element is configured by the semiconductor switching element, and the control circuit is configured by the dedicated integrated circuit having the built-in or external timer, the protection circuit of the excessive current can be easily realized with only the integrated circuit even if the microcomputer is not used.

The above and other objects and novel features of the present invention will become apparent from the following description of the present specification and the attached drawings.

### BRIEF DESCRIPTION OF THE DRAWINGS

FIG. 1 is a perspective view illustrating an exterior of a cordless power tool according to an embodiment of the present invention.

FIG. 2 is a perspective view illustrating an exterior of the cordless power tool viewed from another angle according to the embodiment of the present invention, in which a battery pack 10 is removed.

FIG. 3 is a perspective view illustrating an exterior of the battery pack 10 according to the embodiment of the present invention.

FIG. 4 is a perspective view illustrating a state in which the battery pack 10 illustrated in FIG. 3 is charged.

FIG. 5 is an exploded perspective view of the battery pack 10 illustrated in FIG. 3.

FIG. 6 is a plan view of the battery pack 10 in a state where an upper housing 21 is removed.

FIG. 7 is a circuit diagram of an overcurrent protection circuit according to the embodiment of the present invention.

FIG. 8 is a flowchart illustrating the operation of the overcurrent protection circuit of FIG. 7.

FIG. 9 is a current waveform diagram during operation of the overcurrent protection circuit of FIG. 7.

FIG. 10 is a current waveform diagram during operation of an overcurrent protection circuit according to a second embodiment of the present invention.

FIG. 11 is a flowchart illustrating the operation of the overcurrent protection circuit according to the second embodiment of the present invention.

FIG. 12 is a cross-sectional view of a battery pack according to a third embodiment of the present invention.

FIG. 13 is a circuit diagram of an overcurrent protection circuit according to the third embodiment of the present invention.

FIG. 14 is a circuit diagram of an overcurrent protection circuit according to a fourth embodiment of the present invention.

FIG. 15 is an illustrative view illustrating the operation of a DC motor.

FIG. 16 is a perspective view illustrating a cordless circular saw according to an example of a power tool.

FIG. 17 is a front cross-sectional view of the cordless circular saw illustrated in FIG. 16.

FIG. 18 is a perspective view illustrating a cordless hammer drill according to an example of the power tool.

FIG. 19 is a perspective view illustrating a cordless jigsaw according to an example of the power tool.

### DESCRIPTION OF EXEMPLARY EMBODIMENTS

### First Embodiment

Hereinafter, embodiments of the present invention will be described with reference to the accompanying drawings. In the following description, vertical, horizontal, and anteroposterior directions indicate directions shown in the referred drawings.

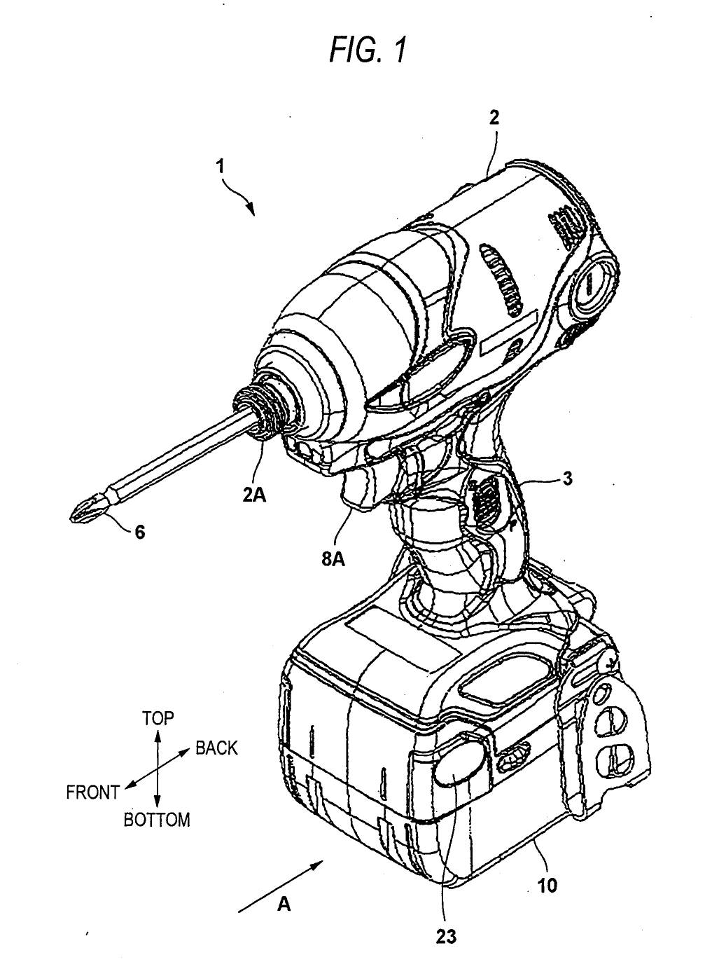

FIG. 1 illustrates an example of a power tool in which a battery pack is mounted according to the present invention. FIG. 1 illustrates an example in which a cordless drill is used as a power tool 1. The power tool 1 includes a main body part 2 as a device main body, and a battery pack 10 detachably attached to the main body part 2. The battery pack 10 is detachably attached to an end (lower end) of a handle part 3 in an extending direction along the anteroposterior direction of the main body part 2. Operating parts 23 are disposed on the battery pack 10, and the operating parts 23 function as a lock mechanism when the battery pack 10 is mounted, and also functions as a release button when the battery pack 10 is removed. As illustrated in FIG. 1, when the battery pack 10 is installed in a handle part 3 in an installation direction indicated by an arrow A along the anteroposterior direction of the main body part 2, the battery pack 10 is mounted in a power tool 1. On the other hand, when the battery pack 10 is moved in a direction opposite to the direction indicated by the arrow A while pushing the operating parts 23, the battery pack 10 can be removed from the handle part 3.

The main body part 2 includes a motor not shown, and a control part not shown which controls the driving of the motor therein, and has a tool retention part 2A that enables a tip tool 6 such as a drill bit to be loaded in a tip portion. The handle part 3 extends downward from the cylindrical main body part 2, and a trigger 8A is disposed on a base portion of the extending portion. The trigger 8A functions as a switch (trigger switch) that supplies an electric power to the motor not shown, and the motor starts to rotate when the operator triggers the trigger 8A.

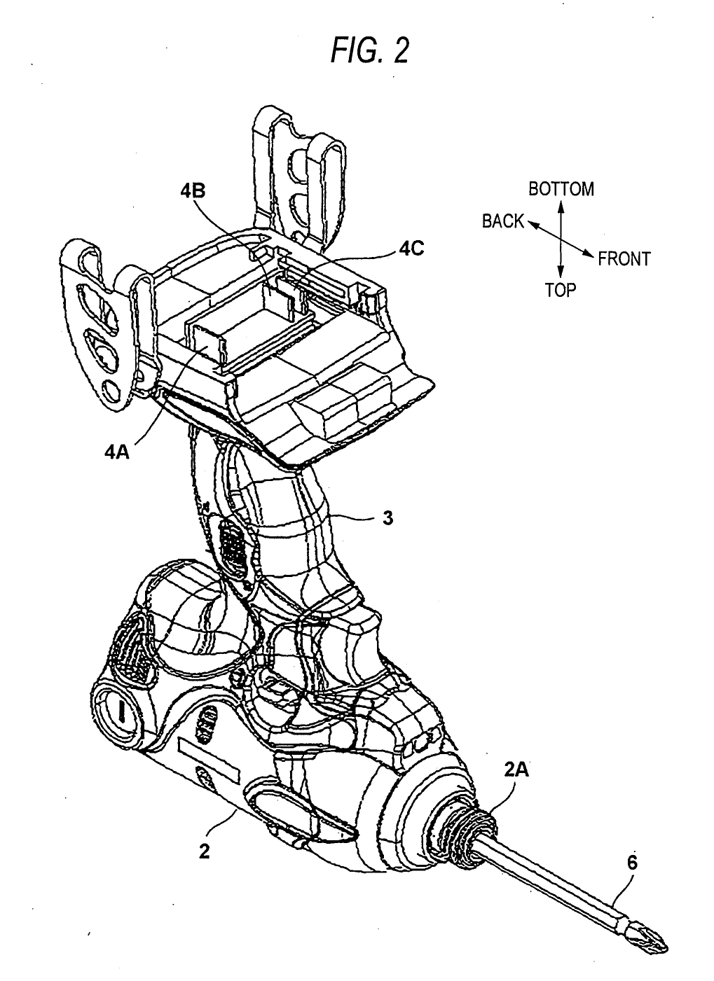

FIG. 2 is a perspective view illustrating an exterior of the cordless power tool 1 viewed from another angle according to the embodiment of the present invention, in a state where a battery pack 10 is removed, and the cordless power tool 1 turns upside down, viewed from below. Plural plate-like terminals 4 (4A, 4B, 4C) are disposed on the end (lower end) of the handle part 3 in the extending direction so as to project forward and downward. Among the plural terminals, the positive terminal 4A and the negative terminal 4B are disposed as power terminals in which a current for driving the motor flows. Further, there is provided a signal transmission terminal 4C for transmitting, to a power tool side, an interruption control signal for interrupting a current flow at the power tool side when an overcurrent or an overdischarge occurs.

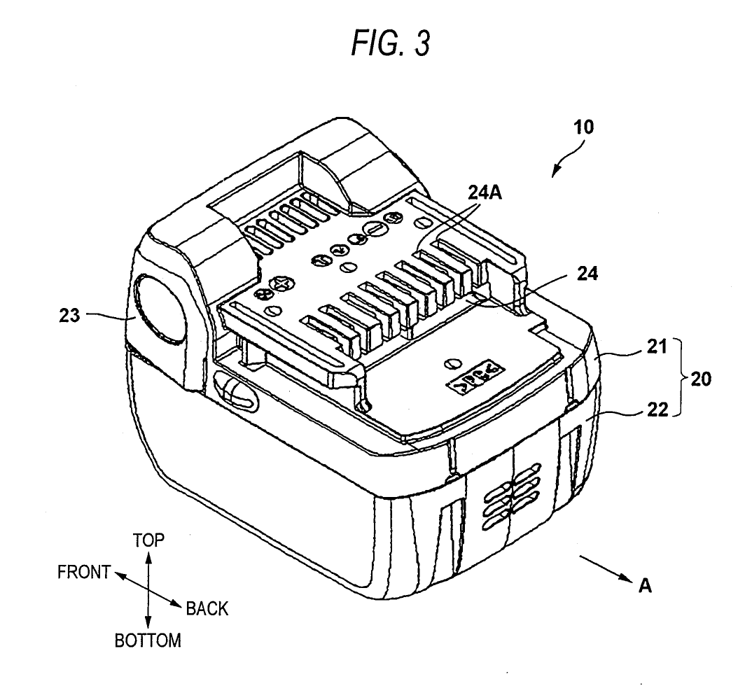

FIG. 3 is a perspective view illustrating an exterior of the battery pack 10 illustrated in FIG. 1. The battery pack 10 is loaded in a direction indicated by an arrow A in the figure. The battery pack 10 includes plural battery cells and a control board that controls charging and discharging operation inside a housing 20. The housing 20 is divided into an upper housing 21 and a lower housing 22. The operating parts 23 are disposed on side surfaces of a front side of the upper housing 21. A terminal insertion part 24 is formed substantially in the center of an upper surface of the upper housing 21, and the battery pack 10 is moved to the terminals 4 from the front side while being slid, whereby the terminals 4 of the main body part 2 are fitted into the terminal insertion part 24 to electrically connect the battery pack 10 to the power tool 1. Eight slits 24A for inserting the terminals thereinto are formed in the terminal insertion part 24 of the upper housing 21 are formed in the terminal insertion part 24 of the upper housing 21. However, there is no need to provide connections terminals for all of those slits 24A. Only a required number of connection terminals are provided for those slits 24A.

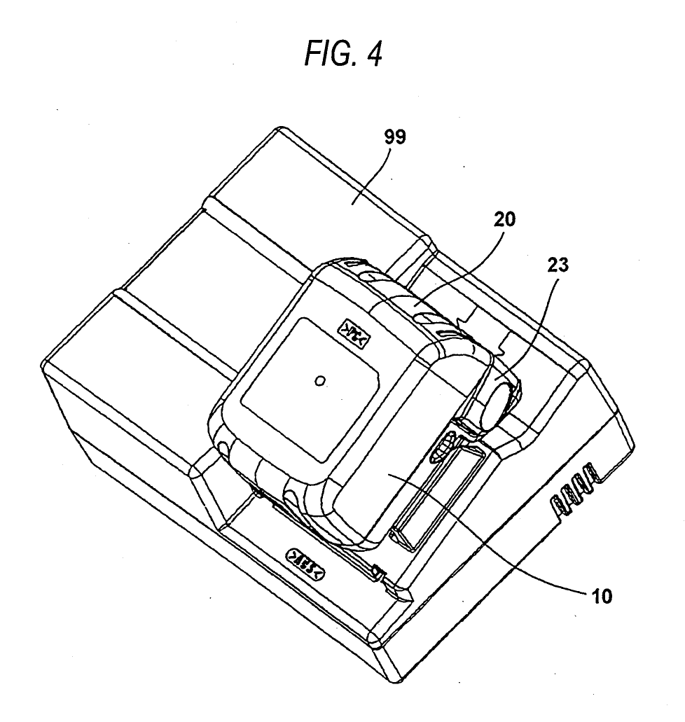

FIG. 4 is a perspective view illustrating a state in which the battery pack 10 illustrated in FIG. 3 is charged. When the battery pack 10 is charged, as illustrated in FIG. 4, the battery pack 10 is removed from the power tool 1, and loaded in a charger 99. The charger 99 generates a given DC voltage and a given DC current for charging with the use of a commercial power supply such as AC 100 V, and charges battery cells accommodated in the set battery pack 10. The charger 99 can be formed of a known charger put on the market, and is irrelevant directly to the present invention, and therefore its description will be omitted.

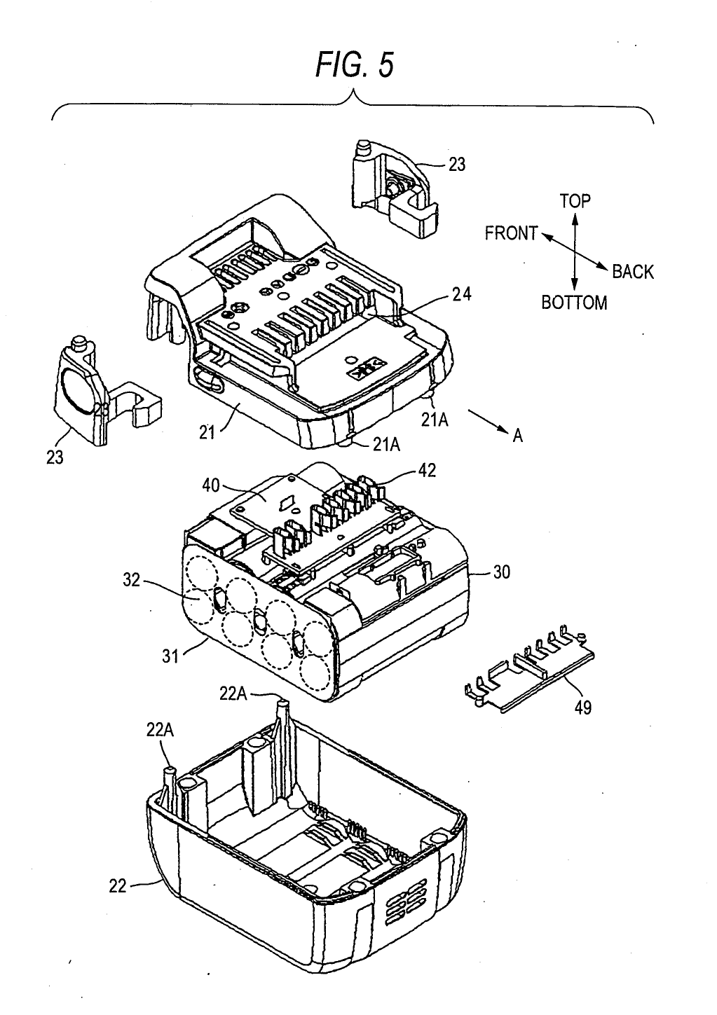

FIG. 5 is an exploded perspective view of the battery pack 10 illustrated in FIG. 3. The battery pack 10 includes the housing 20 formed of a nonconductive member, and a case 30 is accommodated in the housing 20. From the viewpoints of strength and weight, it is preferable to integrally mold the housing 20 with a polymer resin such as plastic. The housing 20 is mainly formed of the upper housing 21 and the lower housing 22, and those upper and lower housings 21 and 22 are engaged with each other through bosses 21A and 22B. In the housing 20, the case 30, a board 40, and a terminal cover 49 are accommodated in the lower housing 22 in order from the below, and covered with the upper housing 21. A pair of operating parts 23 for engaging the housing 20 with the handle part 3 is attached to both sides of the front side of the housing 20. The terminal insertion part 24 is covered with the terminal cover 49 so as not to expose the board 40 to the external.

The case 30 includes, as plural battery cell accommodation parts, a cell frame 31 that holds plural battery cells 32, an electrode part (not shown) that electrically connects between the respective electrodes of the plural battery cells 32, and two connection terminals (not shown) to the connected battery cells 32. The connection terminals are connected to the board 40. Each of the battery cells 32 is a secondary battery such as a lithium-ion battery, and can be charged and discharged by plural times. In this embodiment, four sets of paired lithium-ion batteries each having a nominal voltage of 3.6 V are connected in series to obtain a voltage of 14.4 V.

The board 40 is fixed to an upper side of the case 30 so as to be situated inside the upper housing 21. On the board 40 is mounted a control circuit for controlling the operation of charging and discharging the battery cells 32. Plural terminals 42 are disposed on an upper surface of the board 40. In this embodiment, seven of the terminals 42 are disposed at appropriate distances, and the terminals 4A to 4C of the main body part 2 inserted through the terminal insertion part 24 are engaged with corresponding terminals. The terminals 42 of the battery pack 10 are prepared for several power tools (seven in this embodiment), considering a case in which various power tools are loaded into consideration. However, all of those terminals 42 are not used when the power tool is loaded, and only the necessary terminals 42 are connected.

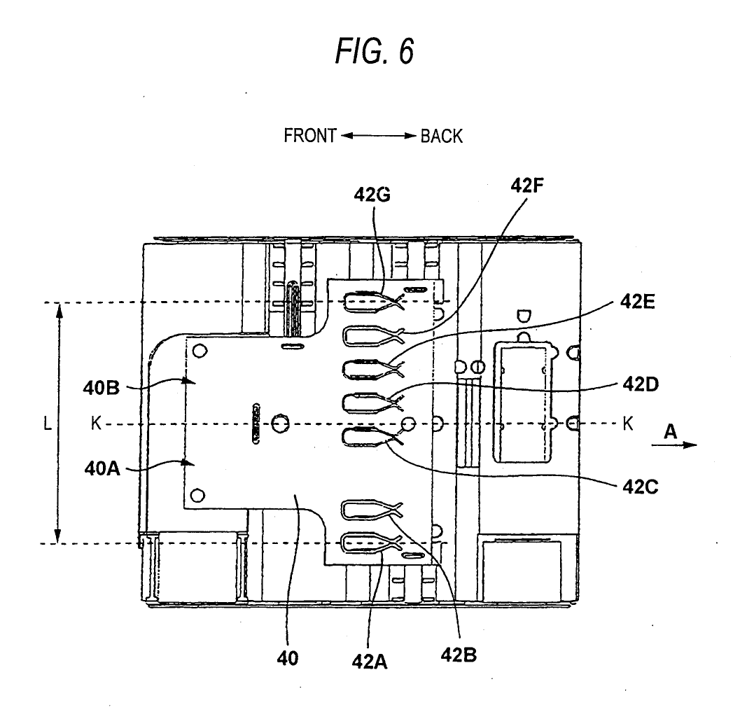

FIG. 6 is a plan view of the battery pack 10 in a state where the upper housing 21 is removed. The seven terminals 42 (42A to 42G) are made up of a positive terminal 42A for charging, a positive terminal 42B for discharging, signal transmission terminals 42C, 42D, 42E, a negative terminal 42F for charging and discharging, and a signal transmission terminal 42G in order from one end of the board 40. The positive terminals 42A and 42B are connected to one (plus side) electrode part of the case 30, and the negative terminal 42F is connected to the other (minus side) electrode part of the battery cells 32. Accordingly, when the battery cells 32 are charged, a current corresponding to a charging voltage flows in the positive terminal 42A and the negative terminal 42F. When the battery cells 32 are discharged, a current corresponding to a load of the power tool 1 is discharged from the positive terminal 42B and the negative terminal 42F. Thus, the positive terminals 42A, 42B, and the negative terminal 42F are used for allowing the current corresponding to the charging and discharging operation of the battery cells 32 to flow between the battery pack 10 and the power tool 1 or the charger 99.

The signal transmission terminals 42C to 42E and 42G are used for discriminating the type and number of accommodated battery cells, for detecting overcharging, for transmitting an output from a thermistor, and for preventing overdischarge or overcurrent, respectively. Control signals for controlling the charging and discharging operation of the battery pack 10 are transmitted through the signal transmission terminals 42C to 42E and 42G.

The positive terminals 42A and 42B are arranged in one 40A of two regions obtained by dividing the board 40 by a virtual center line K-K that passes through a center of a width L of the board 40 and extends in parallel to an insertion direction A. On the other hand, the negative terminal 42F is arranged in the other region 40B divided by the center line K-K. That is, the center line K-K lies between the negative terminal 42F and any one of the positive terminals 42A, 42B. The signal transmission terminals 42C to 42E and 42G are arranged on the board 40 at appropriate distances from locations where the positive terminals 42A, 42B and the negative terminal 42F are disposed. In this embodiment, the board 40 is formed of a double-sided board where various electronic elements configuring a control circuit that will be described later are mounted on upper and lower surfaces of the board 40.

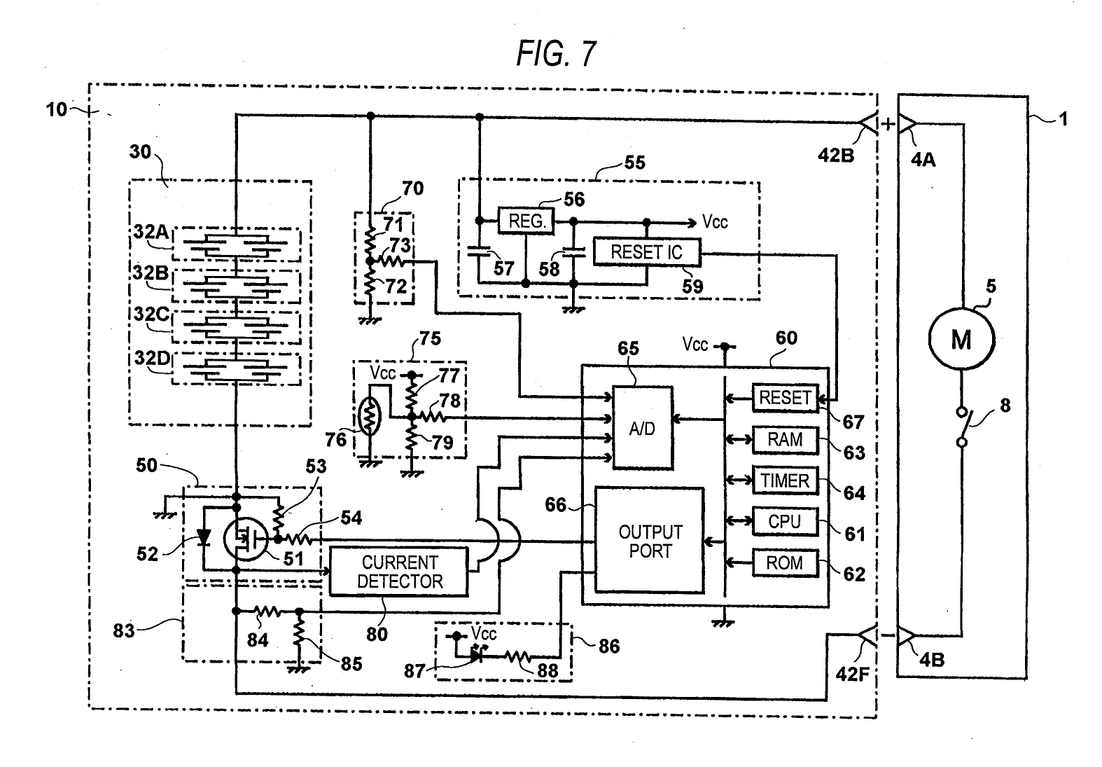

Subsequently, a specific example of an overcurrent protection circuit will be described with reference to FIG. 7. In the power tool according to the present invention, there are proposed three methods consisting of a method in which an overcurrent protection circuit is mounted on the board 40 within the battery pack 10, a method in which the overcurrent protection circuit is mounted within the power tool 1, and a method in which the overcurrent protection circuit is mounted within each of the battery pack 10 and the power tool 1, as a circuit for preventing an overcurrent from the lithium-ion secondary battery. In an example illustrated in FIG. 7, the overcurrent protection circuit is mounted on the board 40 within the battery pack 10. In the present specification, “overcurrent” means two kinds of states, that is, (1) a case in which a discharge peak current exceeds a maximum allowable current value (peak allowable current), and (2) a case in which a discharge current value is smaller than the maximum allowable current value, but such a large current continues to flow for a given allowable time period or more (for example, about a dozen seconds to several dozen seconds) (large-current allowable duration). In this embodiment, attention is mainly paid to (2) the large-current allowable duration, and the overcurrent protection circuit according to this embodiment is actuated when a current of, for example, 20 A or more continues for about 30 to 50 seconds.

FIG. 7 is a circuit diagram of an overcurrent protection circuit according to the embodiment of the present invention. The positive terminal 42B and the negative terminal 42F for discharging the battery pack 10 are connected to the positive terminal 4A and the negative terminal 4B disposed in the power tool 1, respectively. A DC motor 5 and a trigger switch 8 are connected in series between the positive terminal 4A and the negative terminal 4B of the power tool 1. Some control circuit frequently intervenes in a circuit of the actual power tool 1. However, in this embodiment, for simplification of description, a circuit configuration within the power tool 1 includes only the motor 5 and the trigger switch 8.

The battery pack 10 includes the case 30 that accommodates plural battery cells in which the battery cell sets 32A to 32D are connected in series by a connection plate therein. Each of the battery cell sets 32A to 32D is configured by two battery cells connected in parallel. However, each of the battery cell sets 32A to 32D may be configured by one battery cell, or may be configured by three or more battery cells connected in parallel. When the battery pack 10 and the power tool 1 are connected to each other, and the trigger switch 8 of the power tool 1 turns on, a path of a discharge current flowing from a positive terminal of the case 30 to a negative terminal of the case 30 through the power tool 1 is formed. A resistor circuit or a speed governing circuit for adjusting a rotating speed of the motor 5 is normally included in a path of the power tool 1 side. However, in this embodiment, such a circuit is omitted from illustration and description.

In the formed discharge current path, a switching part 50, a constant voltage power supply 55, a battery voltage detector 70, and a trigger detector 83 are connected in a path of the battery pack 10 side. Those respective parts are connected to a microcomputer 60 that is a control unit. The battery pack 10 further includes a battery temperature detector 75 and a display part 86, which are also connected to the microcomputer 60.

The microcomputer 60 includes a central processing unit (CPU) 61, a read only memory (ROM) 62, a random access memory (RAM) 63, a timer 64, an A/D converter 65, an output port 66, and a reset input port 67, which are mutually connected by an internal bus.

The switching part 50 is connected between the negative electrode side of the case 30 and the negative terminal 42F of the battery pack 10, and switches a load current flowing in the power tool 1 under the control of the microcomputer 60. The switching part 50 includes a field effect transistor (FET) 51, a diode 52, and resistors 53, 54, and a control signal is supplied to a gate of the FET 51 from the output port 66 of the microcomputer 60 through the resistor 54. The diode 52 is connected between source and drain of the FET 51 to configure a charge current path during charging of the battery cell sets 32A to 32D.

A current detector 80 detects a current flowing in the FET 51, and has an input side connected to a connection point between a cathode of the diode 52 and a drain of the FET 51, and an output side connected to the A/D converter 65 of the microcomputer 60. The current detector 80 has both of an inverting amplifier circuit and a non-inverting amplifier circuit, and subjects, on the basis of an on-resistance of the FET 51 and an on-voltage of the diode 52, a potential developed by a direction of the current flowing therein to inversion amplification and non-inversion amplification. An output is generated from the inverting amplifier circuit or the non-inverting amplifier circuit according to charging or discharging operation, and the A/D converter 65 of the microcomputer 60 conducts A/D conversion on the basis of that output.

The constant voltage power supply 55 includes a three-terminal regulator 56, smoothing capacitors 57, 58, and a reset IC 59, and a constant voltage VCC output from the constant voltage power supply 55 serves as a power supply of the battery temperature detector 75, the microcomputer 60, the current detector 80, and the display part 86. The reset IC 59 is connected to the reset input port 67 of the microcomputer 60, and outputs a reset signal for initializing the microcomputer 60.

The battery voltage detector 70 detects a battery voltage of the case 30, and includes three resistors 71 to 73. A connection point of the resistors 71 and 72 connected in series between a positive terminal of the case 30 and the ground is connected to the A/D converter 65 of the microcomputer 60 through the resistor 73. A digital value corresponding to the detected battery voltage is output from the A/D converter 65, and the CPU 61 of the microcomputer 60 compares a converted digital value with a first given voltage and a second given voltage. The first given voltage and the second given voltage are stored in the ROM 62 of the microcomputer 60 in advance. The first given voltage is a voltage value regarded as overcharge and the second given voltage is a voltage value regarded as overdischarge.

The battery temperature detector 75 is disposed in the vicinity of the case 30, and detects a temperature of the battery cells 32A to 32D. The battery temperature detector 75 includes a thermistor 76 of a thermosensor element and resistors 77 to 79. The thermistor 76 is connected to the A/D converter 65 of the microcomputer 60 through the resistor 78. A digital value corresponding to the detected battery temperature is output from the A/D converter 65, and the CPU 61 of the microcomputer 60 compares the output digital value with a given value, and determines whether the battery temperature is abnormally high, or not.

The trigger detector 83 includes resistors 84 and 85, and detects ON operation of the trigger switch 8 in the power tool 1. When the trigger switch 8 turns on, because a DC resistance of the DC motor 5 is very small (about several ohms), substantially the battery voltage is applied between the drain and source of the FET 51, and this voltage is divided by resistors 84 and 85 and then input to the A/D converter 65. As a result, the CPU 61 can detect the ON operation of the trigger switch 8.

The display part 86 includes a light emitting diode (LED) 87 and a resistor 88, and turns on or blinks the LED 87 according to an output of the output port 66 of the microcomputer 60. For example, when the battery temperature detected by the battery temperature detector 75 is higher than a given temperature, the display part 86 displays an abnormal battery temperature. Although not shown in FIG. 3, the LED 87 may be disposed, for example, at an arbitrary position of a front surface of the battery pack 10, or may be disposed at another arbitrary position observable by an operator.

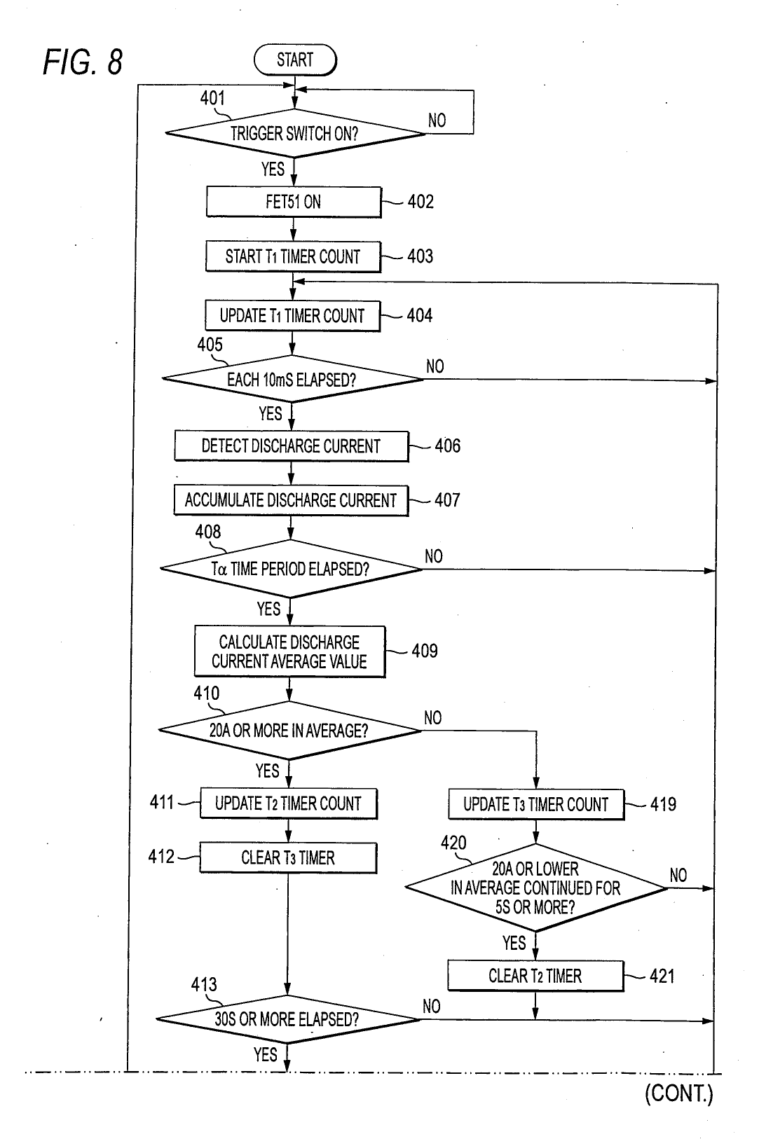

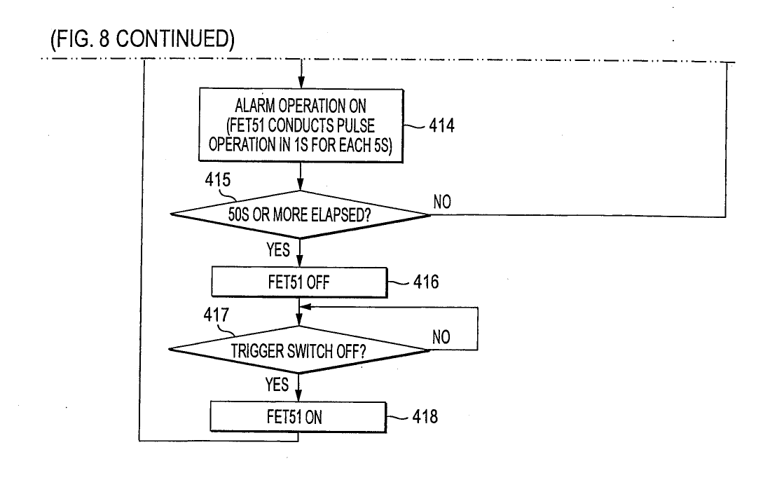

Subsequently, a description will be given of a control procedure of protecting the lithium-ion secondary battery used in the power tool according to the present invention from overcurrent. The control illustrated in a flowchart of FIG. 8 can be executed in a software manner with execution of a program by the aid of the CPU 61 in the microcomputer 60.

When the battery pack 10 is loaded in the power tool 1, and the trigger 8A is depressed, the trigger switch 8 turns on. The CPU 61 first detects whether the trigger switch 8 has turned on, or not, and waits until the trigger switch 8 turns on (Step 401). Upon turning on the trigger switch 8, the CPU 61 outputs a given voltage to the gate of the FET 51 from the output port 66, thereby turning on the FET 51 (rendering the source and the drain conductive) (Step 402). As a result, a DC power is supplied to the DC motor 5 to start the DC motor 5. Then, the CPU 61 starts to measure a time interval with the use of the timer 64 (Step 403).

In this embodiment, the CPU 61 sets a T₁ timer, a T₂ timer, and a T₃ timer for measuring three time intervals. The T₁ timer counts a sampling interval (10 msec) for detecting the current with the use of the output of the current detector 80. The T₂ timer counts a duration for determining whether a given large current or medium current (for example, 20 A or more in average) continuously flows for a given time period (for example, 50 seconds), or not. The T₃ timer counts whether the given time period (for example 5 seconds) has elapsed since the given current value counted by the T₂ timer drops to the given current or lower, or not. That is, the T₃ timer counts a recovery time period from an overcurrent monitoring state to a normal state.

When the FET 51 turns on to start the DC motor 5, the CPU 61 starts to count the T₁ timer (Step 403). Then, the CPU 61 updates the count of the T1 timer (Step 404), and determines whether a count value of the T₁ timer reaches 10 msec (mS), or not (Step 405). If the count value of the T₁ timer does not reach 10 msec, the processing is returned to Step 404. If the count value of the T₁ timer reaches 10 msec, the CPU 61 detects a current by the aid of an output of the current detector 80 (Step 406), and stores the detected current value in the RAM 63, thereby sequentially accumulating a discharge current value for calculating an average current (Step 407).

Then, the CPU 61 detects whether the count value of the T₁ timer reaches a time period T_{α}, or not (Step 408). The time period T_{α} is so-called “dead time period”, and in a time interval of T_{α} or shorter, an average value of the current is not calculated. If the time period T_{α} does not elapse, the processing is returned to Step 404, and if the time period T_{α} elapses, the CPU 61 calculates the average value of the discharge current with the use of the discharge current value stored in the RAM 63 (Step 409). The average value of the discharge current can be calculated by extracting data for the latest T_{α} time period among the discharge current values stored in the RAM 63, and obtaining the average value. Accordingly, in this embodiment, it is important to satisfy T_{α}>10 msec. Also, the time period T_{α}, which is the dead time period, is set to be sufficiently larger than a period during which a striking current of the DC motor 5 flows, so as to be set to such a time interval that the average value of the striking current does not exceed a given current (for example, 20 A) even if the average value of the discharge current is calculated for each time period T_{α}. In this case, since the striking current of the DC motor 5 is not detected in the subsequent steps, the striking current can be substantially prevented from being detected as overcurrent.

Then, the CPU 61 determines whether the calculated discharge current average value exceeds 20 A which is the given current, or not (Step 410). This given current can be arbitrarily set by a designer of the power tool or the battery pack, and can be set according to the discharge characteristic of the secondary battery or the characteristic of the DC motor 5. In this embodiment, the given current is set to 20 A as one reference, but not limited to this value. Not only the reference discharge current that allows continuous discharge, but also a maximum allowable current value that allows a momentary discharge to be instantaneously interrupted even if the momentary discharge occurs can be set (not described in this embodiment). Therefore, it is preferable that the reference discharge current that allows continuous discharge is set to about 20% to 90% of the maximum allowable current value.

Subsequently, in Step 411, the CPU 61 updates the T₂ timer (Step 411), and clears the T₃ timer (Step 412). Then, the CPU 61 determines whether an integrated value of the T₂ timer reaches 30 seconds or more, or not (Step 413). If the integrated value of the T₂ timer does not reach 30 seconds, the processing is returned to Step 404.

In Step 410, if the calculated discharge current average value is 20 A or less which is the given current, the CPU 61 updates the count of the T₃ timer (Step 419), and determines whether the count value of the T₃ timer continues for 5 seconds or more, or not, that is, whether a state in which the calculated discharge current average value is 20 A or less continues for 5 seconds or more, or not (Step 420). If the state continues for 5 seconds or more, the CPU 61 determines that the continuous discharge state of the large current stops, clears the T₂ timer, and returns to Step 404 (Step 421). If the state in which the calculated discharge current average value is 20 A or less does not continue for 5 seconds in Step 420, the CPU 61 returns to Step 404.

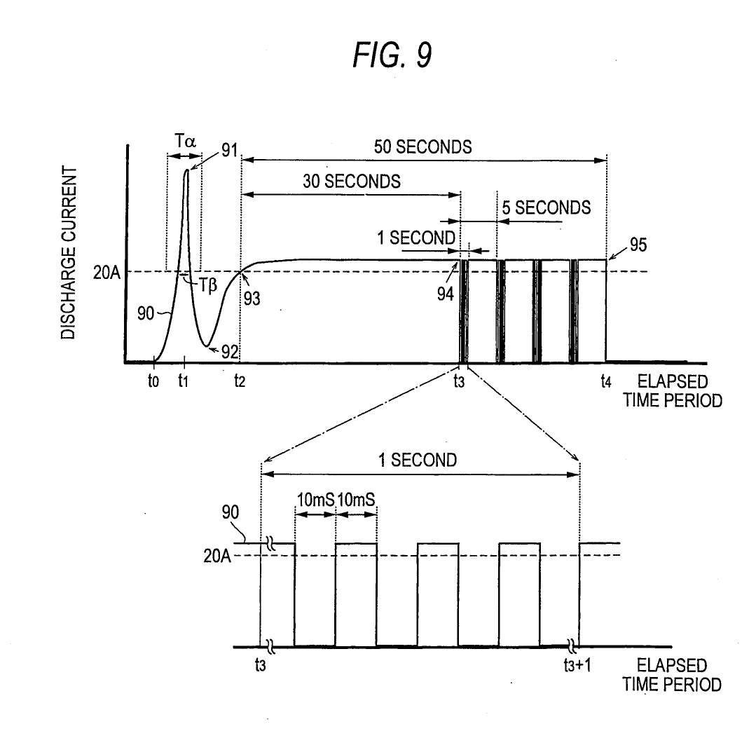

If the calculated discharge current average value of 20 A or more continues for 30 seconds or more in Step 413, the CPU 61 issues an alarm for notifying the operator that the continuous discharge state of the large current (overcurrent state) continues. How to issue the alarm is variously proposed. In this embodiment, the CPU 61 conducts pulse drive so that the current value to be supplied to the FET 51 is decreased in only 1 second for 5 seconds. A driving state during the pulse drive is illustrated in FIG. 9.

FIG. 9 is a current waveform diagram during operation of the overcurrent protection circuit of FIG. 7. The axis of abscissa is an elapsed time period (second), and the axis of ordinate is a discharge current value (unit A) from the battery pack 10. An example of the discharge current with the elapsed time period is indicated by a discharge curve 90. When the trigger 8A is depressed at a time t₀, a considerable striking current flows in the DC motor 5, and a current value thereof far exceeds 20 A as indicated by an arrow 91 at a time t₁. The striking current may exceed 100 A depending on the type of the DC motor 5. However, a time during which the striking current flows is short, and T_{β} during which the current value becomes 20 A or more is within 100 msec at the maximum. In this example, it is preferable that the dead time period T_{α} is about two to four times as long as T_{β}. If the dead time period T_{α} is thus set to be longer, the striking current and the large current continuously flowing can be distinguished from each other.

When the striking current flows in the DC motor 5 to start to accelerate the DC motor 5 at the time t₁, the current flowing in the DC motor 5 is decreased, and the current again starts to increase at a point indicated by an arrow 92. Thereafter, the current value is varied according to rpm of the DC motor 5 and the magnitude of a load. However, the current exceeds a given current, in this embodiment, the discharge current 20 A at a time point indicated by an arrow 93, and at this time point, the T₂ timer starts to count the duration of the large current. When the discharge current measured in the actual power tool 1 is graphed as it is, the current fluctuates so that a smooth discharge curve illustrated in FIG. 9 is not obtained. However, in this embodiment, the discharge current is graphed with the use of the average discharge current value for the latest T_{α} time period, and therefore an influence of the current fluctuation can be reduced.

Since the discharge current of 20 A or more continues for 30 seconds at a time t₃ (time point indicated by an arrow 94), the discharged current is switched in only one second as alarm operation as shown in Step 414 of FIG. 8. The switching operation is to decrease the output of the power tool with a decrease in the average value of the discharge current in only a short time of 1 second, and to allow the operator to recognize the overcurrent state. The switching operation is executed while the microcomputer 60 controls the FET 51.

The discharge curve 90 on a lower side of FIG. 9 is to enlarge a current waveform during the switching operation. FIG. 9 shows the discharge curve 90 for one second from time t₃ seconds to time (t3+1) seconds. The CPU 61 (refer to FIG. 7) controls the FET 51 (refer to FIG. 7) to periodically repeat the on or off operation of the FET 51 for each 10 msec (mS) during the switching operation. As a result, 50 on states and 50 off states of the FET 51 alternately exist in one second from the time t₃ seconds to the time (t₃+1) seconds. In this way, in this embodiment, the switching operation of the FET 51 is conducted in only a first one second for each 5-second interval, thereby enabling the average discharge current during the switching operation to be substantially halved. With the switching operation, the operator can feel that the output is slightly decreased, and the switching operation serves as an alarm function for the operator. Since the operator can thus feel uncomfortable in the operating state of the power tool, the operator can easily know that the large current (or medium current) discharge state from the battery pack 10 continues, and that the DC motor 5 is forcedly stopped shortly after the trigger 8A is continuously depressed as it is.

The start time point (30 seconds after t₂) when the alarm operation is conducted, the execution interval (for each 5 seconds) of the alarm operation, and the switching operation time (1 second), which are described in this embodiment, are exemplified, and those times can be arbitrarily set. Also, the time interval (on state is 10 msec, and off state is 10 msec) for turning on or off the FET 51 is also similarly exemplified, and the on/off operation may be conducted at an arbitrary interval or an arbitrary time ratio. Those times may be appropriately set taking the characteristics of the battery cells 32 incorporated in the battery pack 10, the characteristics of the DC motor 5 in the power tool 1, and the conceivable use conditions of the power tool 1 into consideration.

In this embodiment, when the operator continuously triggers the trigger 8A to continue the operation although the alarm operation is conducted, the CPU 61 controls the FET 51 to turn off to forcedly stop the DC motor 5 at a time t₄ (time point indicated by an arrow 95) where a given time period (50 seconds from t₂) is elapsed.

Again returning to FIG. 8, if the state in which the discharge current average value calculated in Step 415 is 20 A or more continues for 50 seconds or more, the CPU 61 turns off the FET 51 (Step 416). Then, the CPU 61 waits until the trigger switch 8 is turned off by the operator (Step 417), and when the trigger switch 8 is turned off, the CPU 61 again turns on the FET 51, and returns to Step 403 (Step 418).

As described above, according to this embodiment, even in the long-time discharge of the large current or the medium current, which cannot be interrupted by the interrupting function at the time of the excessive peak discharge current, the motor of the power tool can be forcedly stopped. Therefore, the overcurrent state of the battery pack, in particular, the large-current continuous discharge state can be avoided with the result that the battery pack can be effectively prevented from being deteriorated.

Incidentally, in the above embodiment, a reference value of the discharge current is set to 20 A, and a case in which the discharge current is 20 A or more is explained. However, it is not limited thereto. The battery pack may be controlled in the same manner as the above in the case that the discharge current is more than 20 A, for example, 40 A or more.

### Second Embodiment

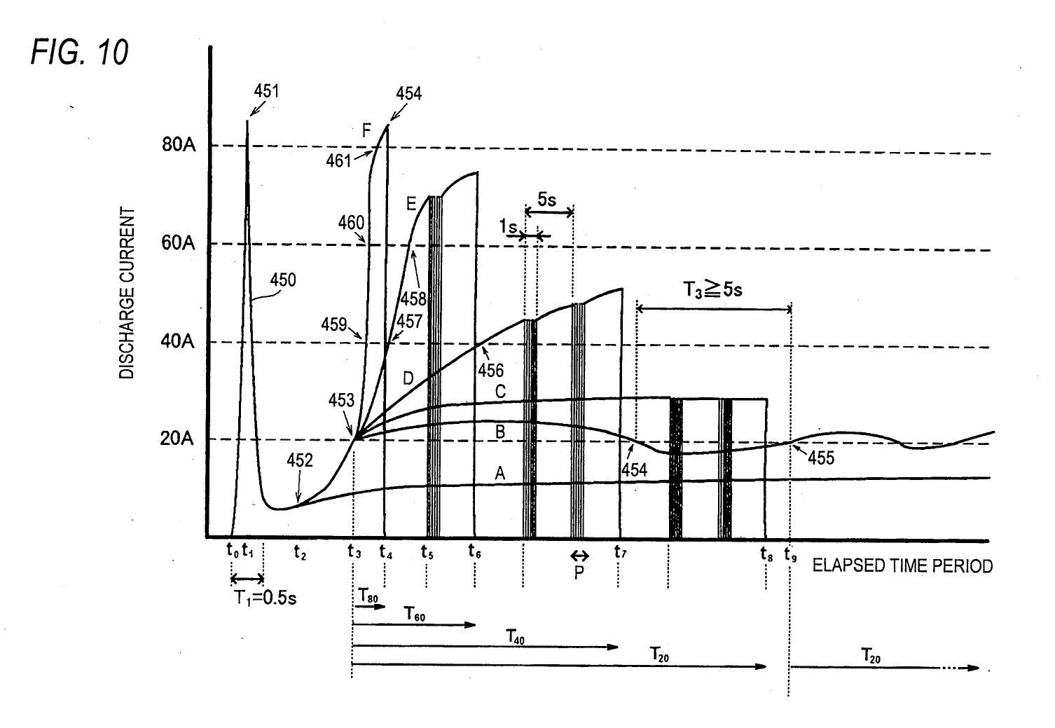

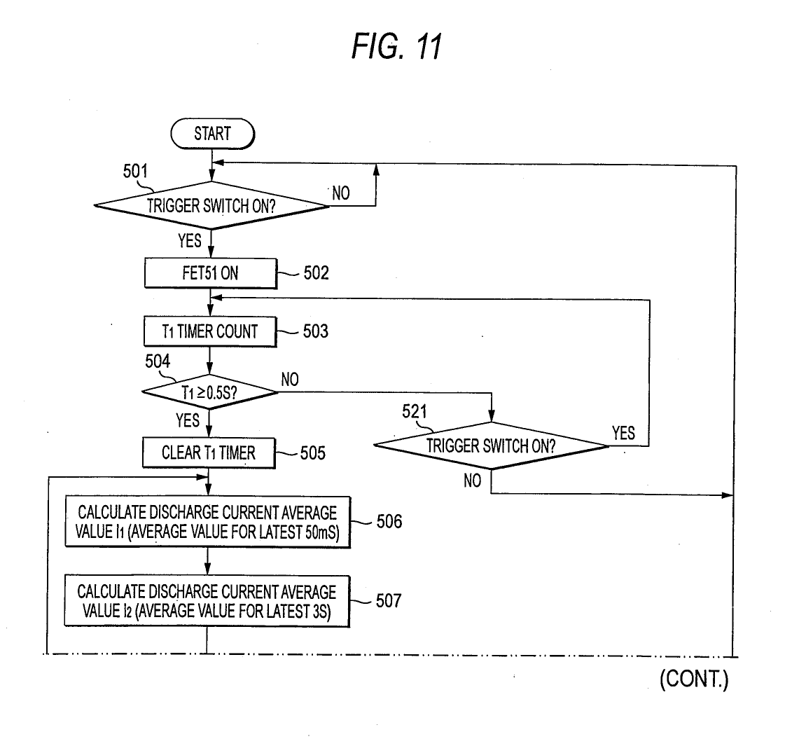

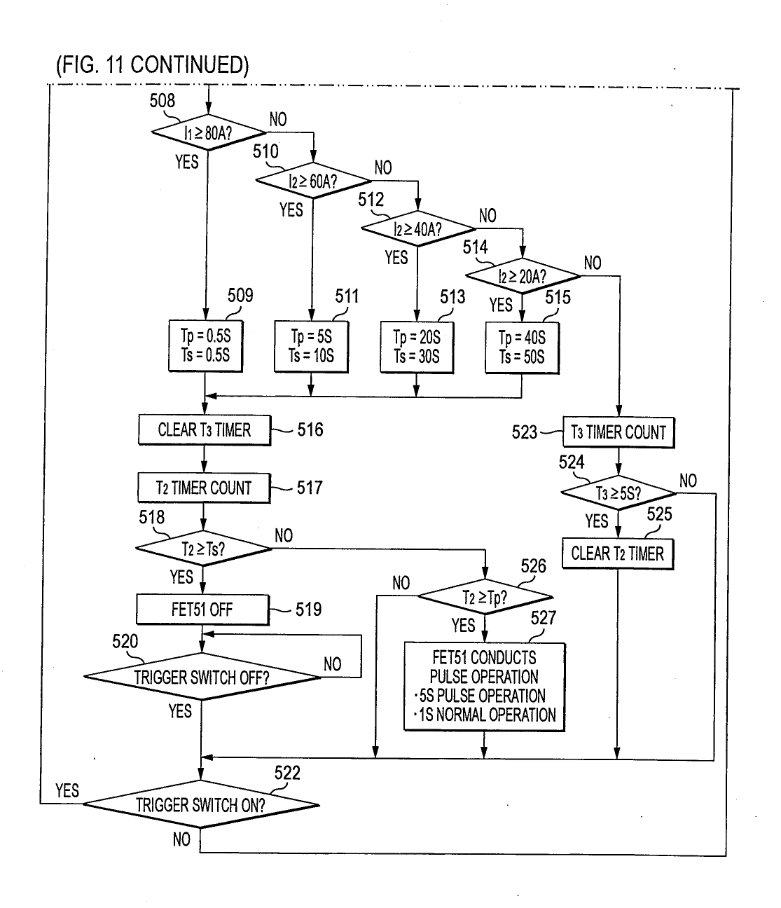

Subsequently, an overcurrent protection circuit according to a second embodiment of the present invention will be described with reference to FIGS. 10 and 11. Like the first embodiment, in the second embodiment, an overcurrent state is detected within the battery pack 10 with the use of the microcomputer 60 mounted on the board 40 of the battery pack 10. However, a program executed by the microcomputer 60 is different from that in the first embodiment, and higher-level overcurrent protection is conducted than that in the first embodiment.

FIG. 10 is a current waveform diagram during operation of an overcurrent protection circuit according to the second embodiment. The axis of abscissa is an elapsed time period (second), and the axis of ordinate is a discharge current value (unit A) from the battery pack 10. The discharge current value is indicated by a discharge curve 450. FIG. 10 illustrates an example in which the discharge curve 450 indicative of discharge is separated from an arrow 452 or 453 into six discharge patterns of curves A to F. When the trigger 8A is first depressed at a time t₀, a considerable striking current flows in the DC motor 5, and a current value thereof exceeds 80 A as indicated by an arrow 451 at a time t₁. The striking current may exceed 100 A depending on the type of the DC motor 5. However, a duration in which the striking current flows is short, and T₁ during which the current value becomes 10 A or more is 0.5 msec at the maximum. In this example, if T₀ to T₁ are set to the dead time period of the overcurrent protection circuit in this embodiment, the striking current of the DC motor 5 and the overcurrent to be monitored can be distinguished from each other.

When the striking current flows in the DC motor 5 to start to accelerate the DC motor 5 at the time t₁, the current flowing in the DC motor 5 is decreased, and the current again starts to increase at a point indicated by an arrow 452. When a load is small in such a case where the power tool 1 is a cordless drill illustrated in FIG. 1, and the tip tool is a wood drill, the discharge current slightly increases at t₂ to t₃ as indicated by the curve A, and thereafter continues this state (in the wood drill, the operation normally ceases within 10 seconds). In this case, since the discharge current value does not reach a lowest threshold value (20 A) for conducting the overcurrent protection in this embodiment, no overcurrent protecting operation is conducted by the microcomputer 60.

The curve C is a discharge current pattern under the same control as that in the state described in the first embodiment. When the striking current flows in the DC motor 5 to start to accelerate the DC motor 5 at the time t₁, the current flowing in the DC motor 5 is decreased, and the current again starts to increase at a point indicated by the arrow 452, and the discharge current value exceeds 20 A at the point of the arrow 453. Then, the microcomputer 60 sets an interrupting time period T₂₀ of the excessive current (means an interrupting time period T when the excessive current is 20 A) to 50 seconds (=t₈-t₃). In this case, in the case of the discharge pattern such as the curve C, the microcomputer 60 conducts the alarm operation for controlling the on/off operation of the FET 51 for each 10 msec, for one second. In the second embodiment, the microcomputer 60 sets a time period for conducting the alarm operation to not 30 seconds but 40 seconds.

On the other hand, in the curve B, the microcomputer 60 sets the interrupting time period T₂₀ of the excessive current at a time t₃. However, since the current value is again decreased to 20 A or lower as indicated by an arrow 454 before T₂₀ is elapsed (immediately after t₇), the discharge current departs from the large current state, and this departure state continues for T₃ seconds (>5 seconds). Therefore, the count of the interrupting time period T₂₀ starting from the time t₃ is cleared. However, since the current value again exceeds 20 A at a time t₉ indicated by an arrow 455, the interrupting time period T₂₀ of the excessive current starting from the time t₉ is again set, and the same control is repeated until the trigger 8A is released.

Subsequently, in the curve D, the current value again starts to increase at the point of the arrow 452, and the discharge current value exceeds 20 A at the point of the arrow 453, and T₂₀ is set as the interrupting time period of the excessive current. Thereafter, the discharge current value further increases, and exceeds 40 A at a point of an arrow 456. Under the circumstances, the microcomputer 60 replaces the interrupting time period T₂₀ of the excessive current with T₄₀. T₄₀ is the interrupting time period when the continuous discharge current value exceeds 40 A, and T₄₀ is set to be shorter than T₂₀, and 30 seconds in this embodiment. It is preferable that a base point of measurement of T₄₀ is not the time point (time t₆) of the arrow 456, but remains the time t₃. When the interrupting time period T₂₀ of the excessive current is replaced with T₄₀, there is a need to quicken the timing of implementing the alarm operation for controlling the on and off operation for each 10 msec. For example, when T₄₀ is set to 40 seconds, the timing of implementing the alarm operation can be set to 30 seconds after t₃. An interval for implementing the alarm operation can be set to 5 seconds, and the on or off operation of the FET 51 can be repeated in only a first one second for each 10 msec.

In the curve E, the discharge current value exceeds 20 A at the point of the arrow 453, and T₂₀ is set as the interrupting time period of the excessive current. Since the discharge current value exceeds 40 A at a point of an arrow 457, the interrupting time period T₂₀ is replaced with T₄₀, and since the discharge current value exceeds 60 A at a point of an arrow 458, the interrupting time period T₄₀ is replaced with T₆₀. T₆₀ is set to be shorter than T₄₀, and 10 seconds in this embodiment. A base point of measurement of T₆₀ remains t₃ with no change. If the base point is not thus changed from the time t₃, since the count value made by the T₂ timer can be used as it is, time management is easy. Even when the interrupting time period T₆₀ is set, before the interrupting time period T₆₀ is elapsed, the discharge current is switched for only one second as the alarm operation before interruption. When the interrupting time period T₆₀ is set to 10 seconds, a start time of the alarm operation can be set to 5 seconds.

In the curve F, the discharge current value exceeds 20 A at the point of the arrow 453, and T₂₀ is set as the interrupting time period of the excessive current. Since the discharge current value exceeds 40 A at a point of an arrow 459, the interrupting time period T₂₀ is replaced with T₄₀. Since the discharge current value exceeds 60 A at a point of an arrow 460, the interrupting time period T₄₀ is replaced with T₆₀. Since the discharge current value exceeds 80 A at a point of an arrow 461, the interrupting time period T₆₀ is replaced with T₈₀. That the discharge current value exceeds 80 A at the time point of the arrow 461 means that the discharge current is an excessive current to be almost instantaneously interrupted. Therefore, T₈₀ is set to a sufficiently short time period, for example, 0.5 seconds. Also, the discharge current is interrupted by the aid of the interrupting time period T₈₀, since there is no time to conduct the alarm operation before the discharge current is interrupted, the CPU 61 suddenly interrupts the discharge current without notice using the alarm operation. Since the base point of measurement of T₈₀ remains t3 as it is, if T₈₀ seconds or more are elapsed from t₃ at the time point of the arrow 461, the CPU 61 immediately turns off the FET 51 to interrupt the discharge current.

As described above, according to the second embodiment, since the allowable duration is changed under the control on the basis of the magnitude of the discharge current, the overcurrent protection can be conducted with high precision on the basis of the magnitude of the discharge current. In the above embodiment, when the interrupting time period is changed in the stated order of T₂₀, T₄₀, and T₆₀, the start point (t₃ in the figure) of the time count after changed is maintained as it is. Alternatively, the count by the T₂ timer may start every time the interrupting time period is changed in the stated order of T₂₀, T₄₀, and T₆₀ without maintaining the start point. Also, if the current value falls below a reference current value for the set interrupting time period for a given time period before the interrupting time period changed in the stated order of T₂₀, T₄₀, and T₆₀ is elapsed, the interrupting time period may be again reset in the stated order of T₆₀, T₄₀, and T₂₀ under the control.

Subsequently, the operation of the overcurrent protection circuit according to the second embodiment of the present invention will be described with reference to a flowchart of FIG. 11. The control illustrated in a flowchart of FIG. 11 can be executed in a software manner with execution of a program by the aid of the microcomputer 60 as in the flowchart illustrated in FIG. 8. In the second embodiment, the microcomputer 60 uses three timers of the T₁ timer, the T₂ timer, and the T₃ timer. Although the T₂ timer and the T₃ timer are used for the same intended purpose as that of the first embodiment, the T₁ timer is different from the T₁ timer of the first embodiment. The T₁ timer detects a dead time period during which no current detection is conducted a given time period after the trigger is depressed, in order to detect no striking current. The T₂ timer counts a time period during which a given current or more continuously flows. The T₃ timer counts whether a given time period is elapsed after the given flowing current or more drops to a given value or lower, or not, that is, counts a recovery time period.

When the battery pack 10 is loaded in the power tool 1, and the trigger 8A is depressed to turn on the trigger switch 8 (Step 501), the CPU 61 outputs a given voltage from the output port 66 to the gate of the FET 51, to thereby turn on the FET 51 (allow a conduction between the source and the drain) (Step 502). As a result, the DC power is supplied from the battery pack 10 to the DC motor 5 to start the DC motor 5. Then, the CPU 61 starts the count of the T₁ timer that counts the elapse of the dead time period in order to allow the peak current caused by the striking current (Step 503). In this embodiment, the dead time period is set as 0.5 seconds. If the T₁ timer does not reach 0.5 seconds in Step 504, the processing is advanced to Step 521 in which it is determined whether the operation of the trigger switch 8 has been changed, or not. If the trigger switch 8 remains on, the processing is advanced to Step 503, and if the trigger switch 8 turns off, the processing is returned to Step 501 (Step 521).

If the T₁ timer reaches 0.5 seconds in Step 504, the T₁ timer is cleared (Step 505), and the CPU 61 calculates a discharge current average value I₁ (Step 506). The discharge current is measured for each given sampling interval (for example, 10 msec interval), and the measured values are sequentially stored in the RAM 63 (refer to FIG. 7). The discharge current average value I₁ is an average of the current values measured in the latest 50 msec among the acquired plural measured values. Similarly, the CPU 61 calculates a discharge current average value I₂ according to the current values measured in the latest 3 seconds among the acquired plural current values (Step 507). If the 50 msec for calculating the discharge current average value I₁ or 3 seconds for calculating the discharge current average value I₂ is not elapsed, the average values may remain 0 without calculation of the discharge current average values I₁ and I₂, or a small number of measured values may be averaged.

Then, the CPU 61 determines whether the discharge current average value I₁ is 80 A or more, or not (Step 508). If the average value I₁ is 80 A or more, the CPU 61 sets a time period Tₚ until the alarm operation (pulse driven) is conducted to 0.5 seconds, and a time period Tₛ for interrupting the FET 51 to 0.5 seconds (Step 509), and advances to Step 516. In this example, the reason that Tₚ=Tₛ is satisfied is because the FET 51 is instantaneously turned off without conducting the alarm operation if I₁≧80 A.

If I₁<80 A is satisfied in Step 508, the CPU 61 determines whether the discharge current average value I₂ is 60 A or more, or not (Step 510). If I₂≧60 A is satisfied, the CPU 61 sets the time period Tₚ until the alarm operation (pulse driven) is conducted to 5 seconds, and the time period Tₛ for interrupting the FET 51 to 10 seconds (Step 511), and advances to Step 516. With this setting, the alarm operation (pulse driven) is executed for one second, five seconds after the discharge current average value I₂ exceeds 20 A, and the FET 51 turns off four seconds after the alarm operation is completed (10 seconds after I₂ exceeds 20 A).

If I₂<60 A is satisfied in Step 510, the CPU 61 determines whether the discharge current average value I₂ is 40 A or more, or not (Step 512). If I₂≧40 A is satisfied, the CPU 61 sets the time period Tₚ until the alarm operation (pulse drive) is conducted to 20 seconds, and the time period Tₛ for interrupting the FET 51 to 30 seconds (Step 513), and advances to Step 516. Likewise, if I₂<40 A is satisfied in Step 512, the CPU 61 determines whether the discharge current average value I₂ is 20 A or more, or not (Step 514). If I₂≧20 A is satisfied, the CPU 61 sets the time period Tₚ until the alarm operation (pulse driven) is conducted to 40 seconds, and the time period Tₛ for interrupting the FET 51 to 50 seconds (Step 515), and advances to Step 516.

If the discharge current average value I₂ falls below 20 A in Step 514, the CPU 61 starts the count of the T₃ timer for clearing the T₂ timer when the average discharge current becomes small (Step 523). If the T₃ timer exceeds 5 seconds, the CPU 61 clears the T₂ timer, and advances to Step 522 (Steps 524 and 525). If the T₃ timer is lower than 5 seconds in Step 524, the CPU 61 advances to Step 522. The CPU 61 determines whether the trigger switch 8 remains on, or not, in Step 522, and if the trigger switch 8 remains on, the CPU 61 advances to Step 506, and if the trigger switch 8 is off, the CPU 61 advances to Step 501.

After clearing the T₃ timer in Step 516 (Step 516), the CPU 61 updates the count value of the T₂ timer (Step 517). Then, the CPU 61 determines whether the count value of the T₂ timer is a set value Tₛ or more for conducting the alarm operation, or not (Step 518). If the count value reaches the time period Tₛ for interrupting the FET 51, the CPU 61 turns off the FET 51 to interrupt the DC power to be supplied to the DC motor 5 (Step 519). Then, the CPU 61 waits until the trigger 8A is released by the operator to turn off the trigger switch 8 (Step 520), and returns to Step 501 upon turning off the trigger switch 8.

If the count value of the T₂ timer is lower than the set value Tₛ in Step 518, the CPU 61 determines whether the value of the T₂ timer is Tₚ or more, or not. If the value is Tₚ or more, the CPU 61 allows the FET 51 to conduct the pulse operation to issue an alarm for notifying the operator that the continuous discharge state of the large current (overcurrent state) is continued (Step 527). The pulse driven state is control for conducting the switching operation to turn on or off the FET 51 every 10 msec in the first 1 second for each five-second interval, as in the drawing on the lower side of FIG. 9.

As described above, according to the second embodiment, since the allowable continuous discharge time period can be variably set according to the magnitude of the discharge current from the battery pack 10, if the excessive current such as the lock current flows, the FET 51 is immediately turned off whereby the battery pack 10 and the power tool 1 can be surely protected. Also, since the plural threshold values for interrupting the discharge from the battery pack 10 are provided, the battery pack 10 and the power tool 1 can be finely protected from the large-current continuous discharge state according to the characteristics and use state of the power tool. Also, the battery pack 10 can be prevented from being deteriorated, and the DC motor 5 can be prevented from being damaged. Further, since the control according to the second embodiment is realized by execution of the program by the microcomputer 60 included in the battery pack 10, diverse overcurrent protection controls can be realized by only a change in the program.

Incidentally, in the above embodiment, a reference value of the discharge current is set to 20 A, and a case in which the discharge current is 20 A or more is explained. However, it is not limited thereto. The battery pack may be controlled in the same manner as the above in the case that the discharge current is more than 20 A, for example, 40 A or more.

### Third Embodiment

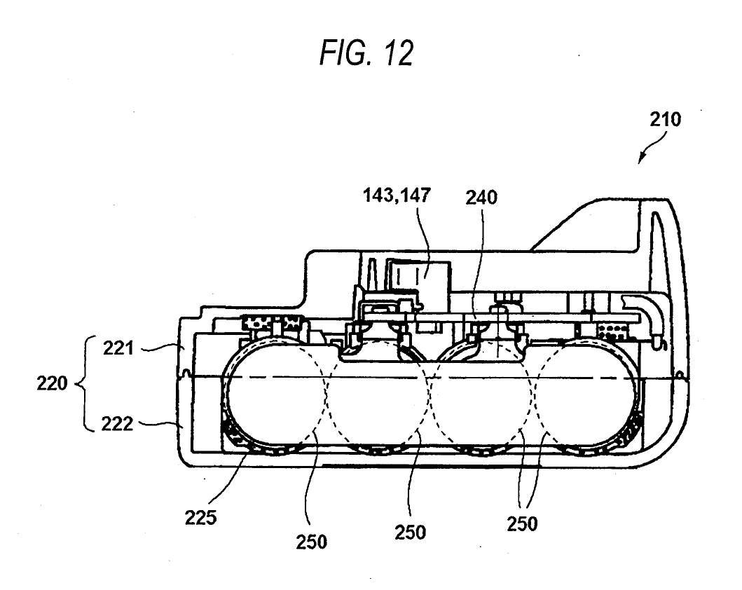

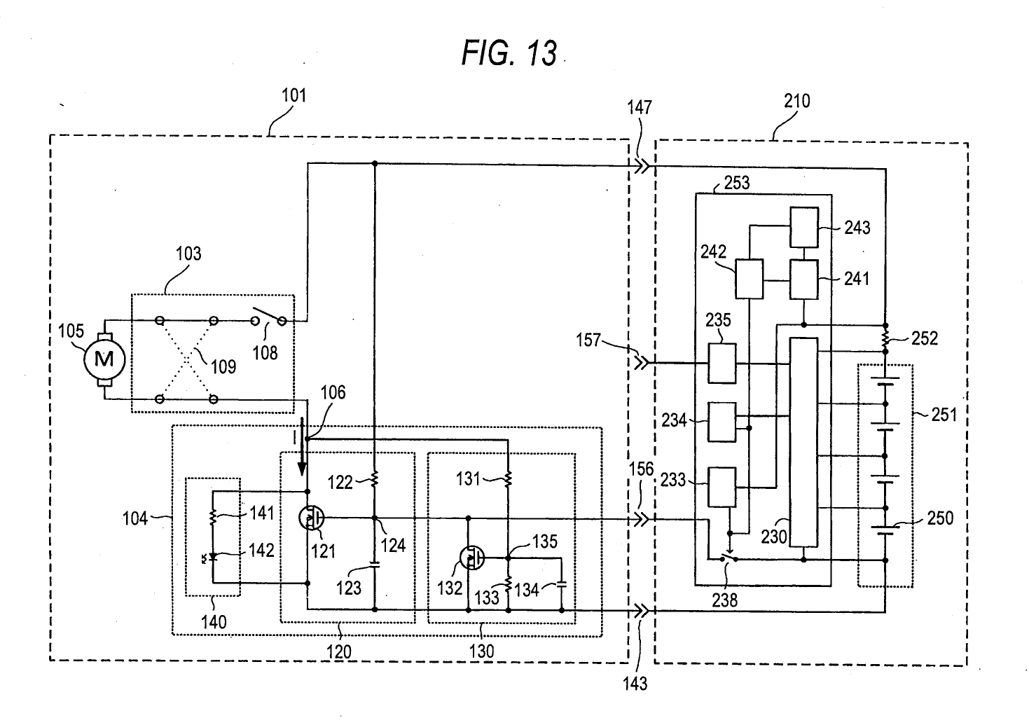

Subsequently, an overcurrent protection circuit according to a third embodiment of the present invention will be described with reference to FIGS. 12 and 13. In the first embodiment, the microcomputer 60 is mounted on the board 40 of the battery pack 10, and an overcurrent state is detected within the battery pack 10 with the use of the microcomputer 60. The third embodiment is identical with the first embodiment in that the overcurrent protection circuit is mounted on a board 240 of a battery pack 210, but is realized by a circuit using a dedicated battery protection IC 253 without use of the microcomputer. Also, an FET for interrupting overcurrent is disposed not within the battery pack 210 but on a power tool 101 side, and the FET can be controlled from the external, and the on and off operation of the FET is controlled from the battery pack 210 side. The same components as those in the second embodiment are denoted by identical reference symbols.

FIG. 12 is a cross-sectional view of the battery pack 210 according to the third embodiment of the present invention. The battery pack 210 is basically identical in configuration with the battery pack 10 described in FIG. 5 except for the number of battery cells 250 accommodated therein. The accommodated battery cells 250 are configured by connecting four lithium-ion batteries each having a nominal voltage of 3.6 V in series. Four of the battery cells 250 are aligned within a case 225, and disposed between an upper housing 221 and a lower housing 222. The board 240 is disposed between an upper side of the case 225 and the upper housing 221, and a positive terminal 147 and a negative terminal 143 are disposed on the board 240.

FIG. 13 is a circuit diagram of the overcurrent protection circuit according to the third embodiment of the present invention. In FIG. 13, the power tool 101 and the battery pack 210 are detachably connected to each other through the positive terminal 147, the negative terminal 143, and an overcurrent overdischarge output terminal 156. The battery pack 210 is also provided with an overcharge output terminal 157, and the overcharge output terminal 157 is connected to the charger 99 but not connected to the power tool 101. The battery pack 101 includes a motor 105 driven by a power supplied from the battery pack 210, a switch unit 103 having a trigger switch 108 that is manually switchable, and a controller 104 that stops the rotation of the motor 105.

The battery pack 210 is connected to the power tool 101 that has been charged to a given voltage or higher in advance to apply the given voltage between the positive terminal 147 and the negative terminal 143. When the trigger switch 108 is closed and an FET 121 is turned on, a closed circuit that goes through the motor 105 between the positive terminal 147 and the negative terminal 143 is formed, and the motor 105 is driven upon receiving a given power.

The battery pack 210 includes a battery cell group 251 having the plural battery cells 250 connected in series, a resistor 252 connected between the positive terminal 147 and the battery cell group 251, and a battery protection IC 253 that detects the overdischarge, overcurrent, and overvoltage of each battery cell 250 to output a signal corresponding to the detection result to the power tool 101 or a charger. The battery protection IC 253 and the resistor 252 are mounted on the board 240 illustrated in FIG. 11.

The resistor 252 and the battery cell group 251 are connected in series between the positive terminal 147 and the negative terminal 143. The battery cells 250 configuring the battery cell group 251 are secondary batteries such as lithium-ion batteries. The battery protection IC 253 monitors overdischarge and overcurrent of the respective battery cells 250, and outputs, to the controller 104, a signal for interrupting the power supply to the motor 105 through the overcurrent overdischarge output terminal 156, upon detecting the overdischarge or overcurrent of any battery cell 250. Also, upon detecting that the battery cells 250 are overcharged, the battery protection IC 253 outputs a signal for stopping the charging operation to the charger through the overcharge output terminal 157. In this embodiment, the rating of the lithium-ion battery is 3.6 V per each battery cell 250, the maximum charging voltage is 4.2 V, and it is determined that overdischarge is conducted when the maximum charging voltage becomes 4.35 V or higher. Also, the overcurrent is directed to a state in which a current flowing in a load exceeds a given value. In this embodiment, the current regarded as overcurrent includes that the discharge current of 20 A or more continues for a given time period (for example, a dozen seconds to several dozen seconds). The overdischarge is directed to a state in which the remaining voltage of the respective battery cells 250 falls below a given value, and in this embodiment, it is assumed that the voltage of one battery cell 250 regarded as the overdischarge is 2 V.

The battery protection IC 253 includes a unit-cell voltage detector 230, an overvoltage detector 235, an overdischarge detector 234, an overcurrent detector 233, and a switch 238. The unit-cell voltage detector 230 detects the individual voltages of the respective battery cells 250, and outputs the detection results to the overvoltage detector 235 and the overdischarge detector 234.

The overvoltage detector 235 receives the voltages of the respective battery cells 250 from the unit-cell voltage detector 230, and determines that overvoltage occurs when the voltage of any battery cell 250 is a given value or more. The overdischarge detector 234 receives the voltages of the respective battery cells 250 from the unit-cell voltage detector 230, and determines that overdischarge occurs when the voltage of any battery cell 250 is a given value or less, and outputs a signal for closing (turning on) the switch 238.

The overcurrent detector 233 detects a current value flowing in the resistor 252, determines that overcurrent occurs when the detected current exceeds an allowable maximum current value, and outputs a signal for closing the switch 238. When the switch 238 is closed in response to the signal from the overdischarge detector 234 or the overcurrent detector 233, the overcurrent overdischarge output terminal 156 and the ground line are connected to each other. Accordingly, in that case, the battery protection IC 253 outputs 0 volts (Lo signal) to the controller 104 of the power tool 101.

A large-current detector circuit 241 detects whether the current flowing in the resistor 252 is 20 A or more, or not, and outputs a signal to a timer counter 242 if the current is 20 A or more. Upon receiving the signal, the timer counter 242 starts the count of the timer, and outputs a signal for closing (turning on) the switch 238 to the switch 238 with elapse of 50 seconds. As described above, when the switch 238 is closed, the battery protection IC 253 outputs 0 volts (Lo signal) to the controller 104 of the power tool 101 through the overcurrent overdischarge output terminal 156. If the current detected by the large-current detector circuit 241 falls below 20 A, the large-current detector circuit 241 outputs a signal to a recovery circuit 243. Upon receiving the signal, the recovery circuit 243 starts the count of a timer different from that described above, and outputs a signal for resetting the timer to the timer counter 242 with elapse of five seconds.

When a state in which the current is 20 A or more thus continues for 50 seconds, the battery protection IC 253 outputs 0 volts (Lo signal) to the controller 104 of the power tool 101. When the current falls below 20 A before the state in which the current is 20 A or more continues for 50 seconds, the count of the timer in the timer counter 242 is suspended. When a state in which the current falls below 20 A continues for five seconds, the count of the timer in the timer counter 242 is reset by the recovery circuit 243. As a result, even if the current again comes to 20 A or more, 0 volts (Lo signal) is not output to the controller 104 of the power tool 101 without further continuing this state for 50 seconds.

The motor 105 of the power tool 101 is connected to the positive terminal 147 and the negative terminal 143 through the switch unit 103 and the controller 104. The switch unit 103 is connected to the motor 105, and includes the trigger switch 108 and a forward reverse switch 109. The trigger switch 108 is connected in series to the motor 105, and operated by the operator to turn on or off the motor 105. The forward reverse switch 109 inverts the polarity of the motor 105 connected to the positive terminal 147 and the negative terminal 143 to change a rotating direction.

Upon receiving the signal for interrupting the power supply from the battery protection IC 253, the controller 104 turns off the FET 121 to interrupt the closed circuit for supplying the power to the motor 105, and stops the power tool 101. The controller 104 includes a main current switch circuit 120, a main current switch-off holding circuit 130, and a display part 140.

The main current switch circuit 120 includes the FET 121, a resistor 122, and a capacitor 123. The FET 121 has a drain connected to the motor 105, a gate connected to the overcurrent overdischarge output terminal 156, and a source connected to the negative terminal 143, respectively. The resistor 122 is connected between the positive terminal 147 and the gate of the FET 121. The capacitor 123 is connected between the gate and source of the FET 121. The gate of the FET 121, the resistor 122, and the capacitor 123 are connected at a contact point 124.

The FET 121 is on while an electric power is normally supplied from the battery pack 210 to the motor 105. That is, when the power tool 101 and the battery pack 210 are connected to each other, the battery voltage is applied to the contact point 124 (gate of the FET 121) through the resistor 122. Therefore, the FET 121 turns on. On the other hand, when the overdischarge or overcurrent is detected by the battery protection IC 253, and 0 volts (Lo signal) is input to the gate of the FET 121 from the overcurrent overdischarge output terminal 156, the FET 121 turns off to interrupt the power supply to the motor 105.

The main current switch-off holding circuit 130 includes an FET 132, resistors 131 and 133, and a capacitor 134. The FET 132 has a drain connected to the gate of the FET 121 and the overcurrent overdischarge output terminal 156, and a source connected to the negative terminal 143. Also, the FET 132 has a gate connected to the motor 105 and the drain of the FET 121 through the resistor 131, and also connected to the negative terminal 143 through the resistor 133 and the capacitor 134 which are connected in parallel to each other. When a voltage is developed in a contact point 135 on a gate side of the FET 132, the FET 132 turns on, and the contact point 124 connected to the drain of the FET 132 is connected to the negative terminal (ground line) 143. Because the contact point 124 is connected to the gate of the FET 121, the gate of the FET 121 is also connected to the negative terminal 143, and the FET 121 turns off upon turning on the FET 132.

The display part 140 includes a resistor 141 and an LED 142, and is connected in parallel between the drain and source of the FET 121. When the trigger switch 108 is off, or the FET 121 turns on, and the trigger switch 108 turns on to supply the electric power to the motor 105, since there is no potential difference between both ends of the display part 140, the LED 142 does not turn on. On the other hand, when the overdischarge or overcurrent is detected to turn off the FET 121, a potential difference occurs between the drain and the source. Therefore, a current flows through the resistor 141 to turn on the LED 142, thereby indicating a state in which the overdischarge or overcurrent is detected. As a result, the operator can easily recognize a state in which the power tool 101 cannot be operated by overdischarge.

As described above, according to the third embodiment, the battery protection IC 253 disposed within the battery pack 210 can instruct the power tool to interrupt the continuance of the excessive current generated in the use of the power tool for a given time period or more. As a result, an abnormal temperature rise of the battery pack 210 can be prevented to lengthen the lifetime. In the third embodiment, the battery pack 210 has the four battery cells 250 merely connected in series, and has a tendency to increase the amount of current discharged from the respective battery cells 250 more than the battery pack 10 having the battery packs connected in parallel as in the first embodiment. Accordingly, if the discharge current is regulated with the use of the battery protection IC 253 disposed in the battery pack 210 as in this embodiment, the lifetime of the battery cells 250 can be remarkably extended.

### Fourth Embodiment

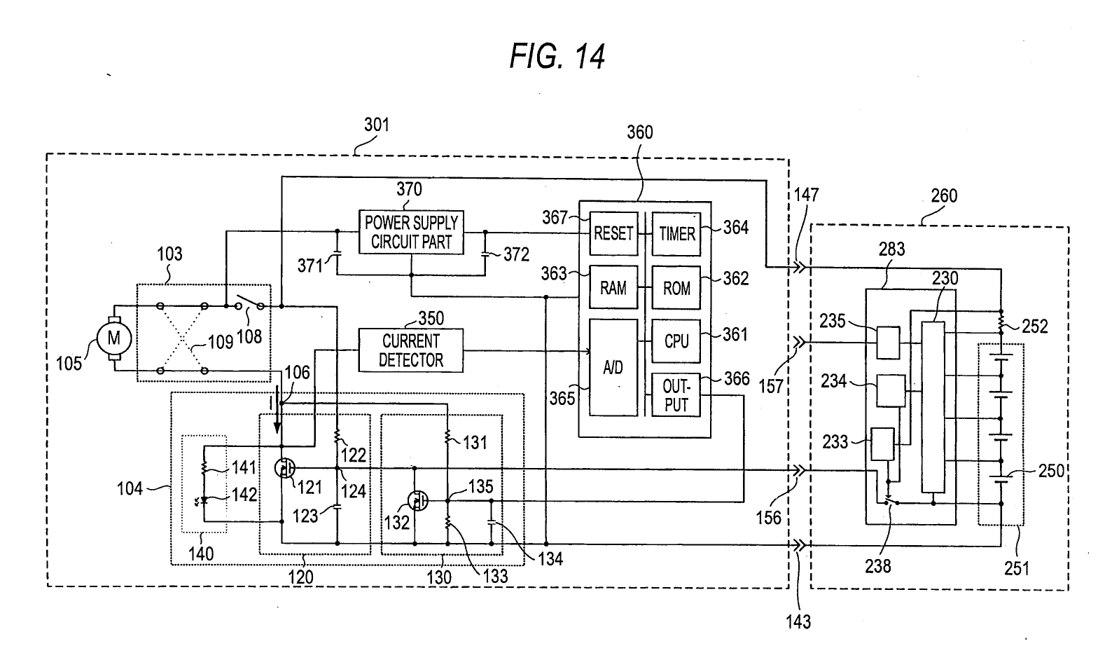

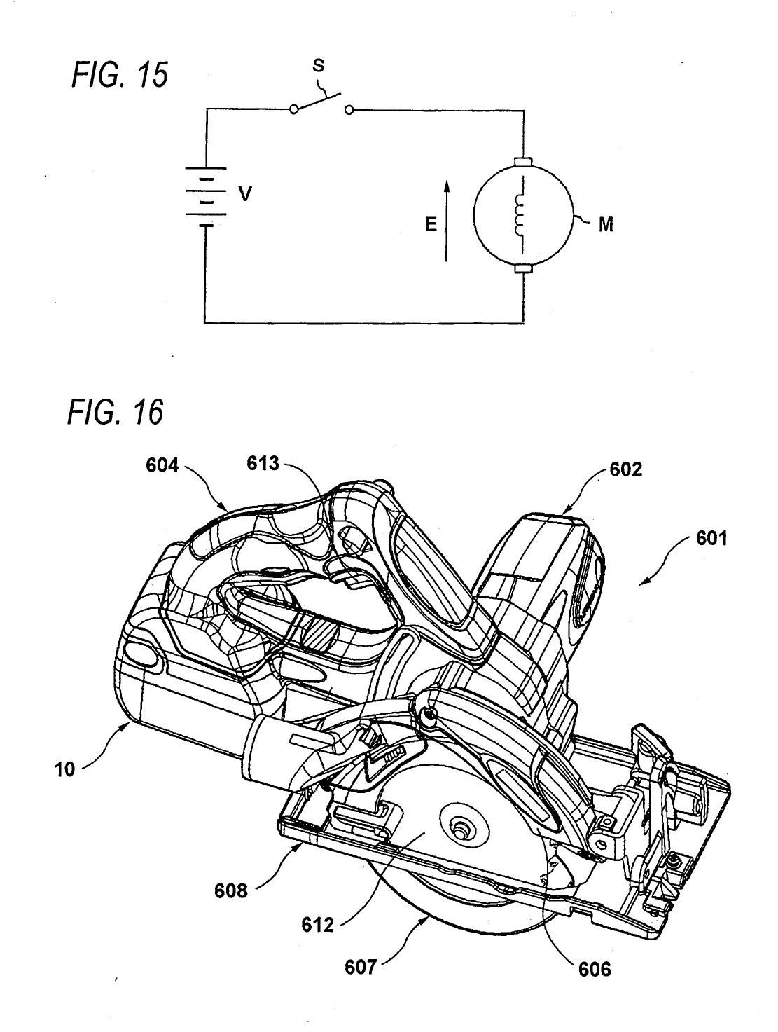

An overcurrent protection circuit according to a fourth embodiment of the present invention will be described with reference to FIG. 14. Prior to description of the fourth embodiment, another example of the power tool will be first described with reference to FIGS. 16 to 19. In the first embodiment, the cordless drill is exemplified as the power tool. The cordless drill almost completes work such as drilling work normally in about several seconds, and hardly actually requires the overcurrent protection circuit described in the first to third embodiments. Therefore, a battery pack having no overcurrent protection circuit is practically sufficient for the power tool such as the cordless drill. However, it is preferable that some of the power tools have the overcurrent protection circuit.

FIG. 16 is a diagram illustrating a cordless power tool requiring the overcurrent protection circuit in which a cordless circular saw 601 is illustrated as the power tool. FIG. 16 is a perspective view of the cordless circular saw 601 viewed obliquely from front. The cordless circular saw 601 rotates a circular saw blade 612 with rotation of the motor by the aid of the battery pack 10. The cordless circular saw 601 has a housing 602 that is an outer frame, and the battery pack 10 is loaded posterior to the housing 602. The battery pack 10 can be of the same structure as that described in FIGS. 3 to 6 or FIG. 12 except for the control circuit part. On the outer side of the circular saw blade 612 are disposed a saw cover 606 that is an outer frame having a shape covering substantially a front half side of the circular saw blade 612, a safety cover 607 that protects the circular saw blade 612 shaped to cover substantially a lower half of an outer periphery of the circular saw blade 612, and a base 608 having an opening that enables the circular saw blade 612 to be projected downward from a bottom thereof. A handle part 604 having a trigger 613 partially accommodated therein is formed above the circular saw blade 612, and the battery pack 10 is loaded in the vicinity of a lower end of the handle part 604.

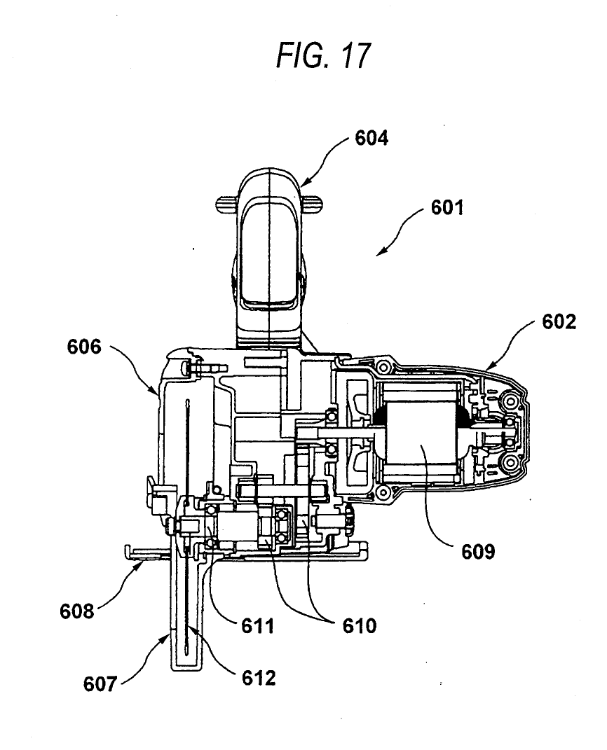

FIG. 17 is a front cross-sectional view of the cordless circular saw 601 illustrated in FIG. 16. A motor 609 is accommodated in the interior of the housing 602, and a rotating force of the motor 609 is decelerated at a given ratio through a reduction mechanism 610, and then transmitted to an output shaft 611. The circular saw blade 612 is attached to a leading end of the output shaft 611, and rotationally driven by the motor 609.

In the cordless circular saw 601, if a cut distance of an object to be cut is long, the motor 609 can be continuously rotated for 10 seconds or more. Also, in the circular saw, the magnitude of a load on the motor 609 is changed according to the magnitude of a force with which the operator presses the handle part 604 toward wood or the like. In particular, when the wood to be cut is hard or has a large number of strings, and the operator cuts the wood while exerting a strong force on the handle part 604, the current flowing in the motor 609, that is, the discharge current from the battery pack 10 becomes large, and the large current may continue for a long time period.

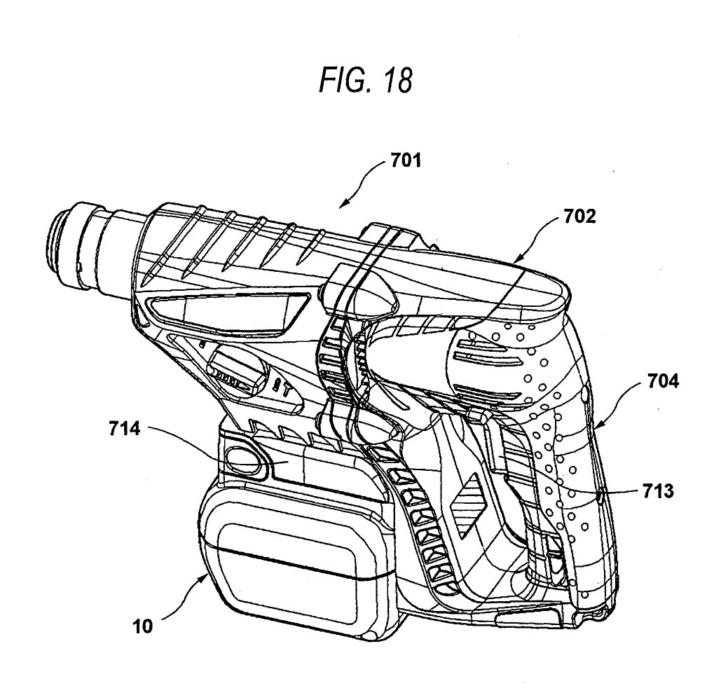

FIG. 18 is a diagram illustrating another power tool requiring the overcurrent protection circuit, that is, a cordless hammer drill 701, and a perspective view taken obliquely from back. Referring to FIG. 18, the cordless hammer drill 701 has a handle part 704 at the rear of a housing 702. A trigger 713 is disposed in a part of the handle part 704. A battery attaching part 714 is disposed below a front side of the housing 702, and the battery pack 10 is attached to the battery attaching part 714. The cordless hammer drill 701 is used for work such as drilling of concrete, predrilling of an anchor, core bit work, breaking, and ditch digging, and a time period required for one work may exceed ten seconds. Accordingly, in the cordless hammer drill 701, the use of the overcurrent protection circuit according to the present invention is preferable from the viewpoints of not only protection of the battery pack 10, but also the motor protection.

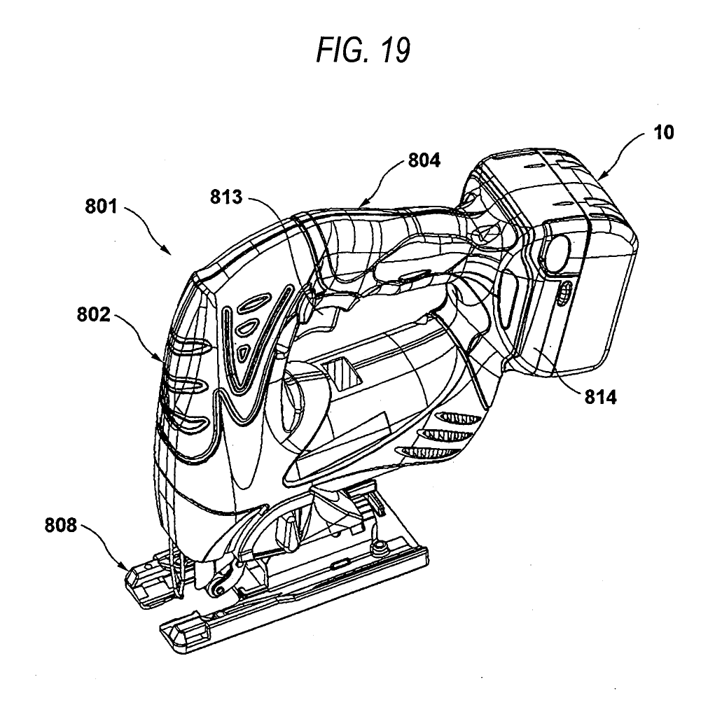

FIG. 19 is a perspective view taken obliquely from front illustrating still another power tool requiring the overcurrent protection circuit, that is, a cordless jigsaw 801. Referring to FIG. 19, the cordless jigsaw 801 includes a handle part 804 above a housing 802, and a trigger 813 is disposed in the handle part 804. The battery pack 10 is loaded at the rear of the handle part 804. The base 808 having an opening that enables a saw blade (not shown) to be projected downward from a bottom thereof is disposed below the housing 802. The battery pack 10 is attached to the battery attaching part 814.

The cordless jigsaw 801 is used for curve cutting work of wood, and a time period required for one work may exceed a dozen seconds to several dozen seconds. Also, when the operator pushes wood through the handle part 804 with a strong force when conducting curve cutting, a load exerted on the motor is increased, resulting in a tendency to increase the flowing current. Accordingly, in the cordless jigsaw 801, the use of the overcurrent protection circuit according to the present invention is preferable from the viewpoints of not only protection of the battery pack 10, but also the motor protection.

As described above, in the power tools illustrated in FIGS. 16 to 19, the use of the battery pack having the overcurrent protection circuit is greatly effective in the prevention of deterioration and the longer lifetime of the battery pack 10. However, there are several kinds of battery packs that can be loaded in the power tool according to a difference in the capacity and a difference in the battery cell even if the battery packs have the same voltage, and there is also a battery pack having no overcurrent protection circuit therein. Under the circumstances, in the fourth embodiment, the overcurrent protection circuit is disposed within the power tool.

FIG. 14 is a circuit diagram of an overcurrent protection circuit according to the fourth embodiment of the present invention. In FIG. 14, the same circuit elements as those in FIG. 13 are denoted by identical reference symbols, and a repetitive description will be omitted. In the fourth embodiment, a given overcurrent flowing for a given time period or more is not detected on a battery pack 260 side, but a microcomputer 360 is disposed within a power tool 301, and the detection of the overcurrent state and the current interruption to the motor 105 are controlled by a microcomputer 360.

The microcomputer 360 includes a central processing unit (CPU) 361, a ROM 362, a RAM 363, a timer 364, an A/D converter 365, an output port 366, and a reset input port 367. Those components are connected to each other by an internal bus.

A current detector 350 detects a current flowing in the FET 121, and has an input side connected to a connection point of the drain of the FET 121, and an output side connected to an A/D converter 365 of the microcomputer 360. The current detector 350 includes an amplifier circuit, and amplifies a potential developed in a direction of the flowing current on the basis of an on-resistance of the FET 121. An output is thus generated in the amplifier circuit according to the discharge, and the A/D converter 365 of the microcomputer 360 converts the output of the amplifier circuit into a digital signal.

A power supply circuit part 370 includes a three-terminal regulator, and generates a constant voltage Vcc to be applied to the microcomputer 360. The power supply circuit part 370 is connected in parallel to smoothing capacitors 371 and 372. Further, the power supply circuit part 370 is connected to a reset input port 367 of the microcomputer 360, and outputs a reset signal to the reset input port 367 to initialize the microcomputer 360.

With the above circuit configuration, when the microcomputer 360 detects that the trigger switch 108 is depressed, a current value is acquired by the current detector 350, a continuation status of a large current flowing in the motor 105 is monitored according to a procedure illustrated in FIG. 8, and when the continuation time period reaches a given time period or more, the alarm operation is conducted for the operator. When the large current further continues, the microcomputer 360 outputs a high signal to the gate of the FET 132 through the output port 366 whereby the FET 132 turns on to set a voltage between the source and gate of the FET 132 to 0 volts. As a result, the gate signal of the FET 121 becomes 0 volts (Lo signal), the gate signal of the FET 121 turns off, a path of current to be supplied to the motor 105 is interrupted to stop the rotation of the motor 105.

As described above, in the fourth embodiment, since the microcomputer 360 is disposed on the power tool 301 side to protect from overcurrent, there is no need to provide means for detecting overcurrent continuing for a given time period or more. Accordingly, a battery protection IC 283 does not include the large-current detector circuit 241, the timer counter 242, and the recovery circuit 243 illustrated in FIG. 13. The battery protection IC 283 included in the battery pack 260 of FIG. 14 can be formed of a general-purpose IC put on the market, including a circuit for protection from an excessive peak current and a circuit for protection from overcharge during the charging operation, and there is no need to provide a dedicated circuit at the battery pack for monitoring that the large current continues for a dozen seconds to several dozen seconds.

The present invention has been described above on the basis of the embodiments. However, the present invention is not limited to the above-mentioned embodiments, but can be variously changed without departure from the subject matter of the invention. For example, the power tool 301 illustrated in FIG. 14 may be connected with the battery pack 210 illustrated in FIG. 13 as it is. In this case, both of the overcurrent protection circuit provided on the power tool 301 side and the overcurrent protection circuit provided on the battery pack 210 operate. The motor 105 is stopped due to any overcurrent protection circuit that first operates, with the results that the power tool can be realized with the high redundancy of the overcurrent protection circuit and the higher reliability.

The above-mentioned battery pack can be used for not only the power tool, but also a cordless cleaner, a cordless work light, a cordless spray, other cordless electric devices and cordless work devices. Also, control conditions (interruption time period, alarm operation time period) for protection from the large-current continuous discharge are not limited to the above-mentioned examples, and may be arbitrarily set according to the power tools to be used and the work characteristics. Further, the alarm operation is realized by conducting the high-speed switching operation (pulse driven) for one second in the above-described embodiments. However, the present invention is not limited to this configuration, but an alarm may be issued to the operator by other arbitrary methods.

1. A power tool comprising:
a battery cell group including a plurality of secondary battery cells;
a switching element;
a trigger switch;
a motor to which an electric power is supplied from the battery cell group through the switching element and the trigger switch;
a current detector configured to detect a current value flowing in a current path that passes through the battery cell group, the switching element, and the motor; and
a controller configured to receive a detection signal from the current detector and controls on/off operation of the switching element,
wherein if the current detector detects that the current value flowing in the battery cell group continuously exceeds a given value for a first time period, the controller conducts one of alarm display and alarm control for allowing an operator to recognize that a high load operation continues, and
wherein if the current value continuously exceeds the given value for a second time period longer than the first time period, the controller turns off the switching element to interrupt the current path.

2. The power tool according to claim 1, wherein
the controller includes a microcomputer having a timer, and
the microcomputer counts a duration of a state in which the detected current value exceeds the given value by using a signal from the current detector and the timer.

3. The power tool according to claim 1, wherein
the controller includes a dedicated integrated circuit having a built-in or external timer, and
the integrated circuit counts a duration of a state in which the detected current value exceeds the given value by using a signal from the current detector and the timer.

4. The power tool according to claim 2, wherein the battery cell group is detachably attached to a main body of the power tool as a battery pack stored in a housing.

5. The power tool according to claim 4, wherein the controller and the switching element are disposed within the battery pack.

6. The power tool according to claim 4, wherein the controller and the switching element are disposed on a main body in which the trigger switch and the motor are disposed.

7. The power tool according to claim 6, wherein
the controller is disposed within the battery pack,
the switching element is disposed on the main body side, and
the battery pack includes a connection terminal that outputs a control signal of the switching element to the main body.

8. The power tool according to claim 1, wherein
the switching element includes a field effect transistor, and
under the alarm control, the controller repeats the on/off operation of the switching element by a plurality of times at short time intervals when the first time period is elapsed.

9. A power tool comprising:
a battery cell group including a plurality of secondary battery cells;
a switching element;
a trigger switch;
a motor to which an electric power is supplied from the battery cell group through the switching element and the trigger switch;
a current detector configured to detect a current value flowing in a current path that passes through the battery cell group, the switching element, and the motor; and
a controller configured to turn off the switching element if the current detector detects an excessive current for a given time period or more,
wherein the controller executes a notice control for notifying an operator that the switching element is turned off before the switching element is turned off.

10. The power tool according to claim 9, wherein the controller turns off the switching element if the excessive current is not eliminated until the given time period is elapsed since the notice control is executed.

11. The power tool according to claim 9, wherein the notice control repeats the on/off operation of the switching element by a plurality of times at short time intervals.

12. A battery pack comprising:
a battery cell group including a plurality of secondary battery cells;
a control circuit configured to monitor a discharge current from the battery cell group;
a connection terminal configured to be connected to a battery-driven-device; and
a switching element configured to interrupt a discharge path from the secondary battery cells to the connection terminal,
wherein the control circuit interrupts the switching element if the discharge current from the secondary battery cells exceeds an allowable discharge maximum value, and
wherein the control circuit interrupts the switching element if the discharge current from the secondary battery cells continuously exceeds a reference current value lower than the allowable discharge maximum value and falls below the allowable discharge maximum value for a first time period.

13. The battery pack according to claim 12, wherein
the switching element includes a semiconductor switching element, and
the control circuit includes a microcomputer having a timer.

14. The battery pack according to claim 13, wherein
the switching element includes a semiconductor switching element, and
the control circuit includes a dedicated integrated circuit having a built-in or external timer.

15. A power tool comprising:
at least one secondary battery cell;
a switching element;
a trigger switch;
a motor to which an electric power is supplied from the battery cell through the switching element and the trigger switch;
a current detector configured to detect a current value flowing in a current path that passes through the battery cell, the switching element, and the motor; and
a controller configured to receive a detection signal from the current detector and controls on/off operation of the switching element,
wherein if the current detector detects that the current value flowing in the battery cell continuously exceeds a given value for a first time period, the controller conducts one of alarm display and alarm control for allowing an operator to recognize that a high load operation continues, and
wherein if the current value continuously exceeds the given value for a second time period longer than the first time period, the controller turns off the switching element to interrupt the current path.

16. A power tool comprising:
at least one secondary battery cell;
a switching element;
a trigger switch;
a motor to which an electric power is supplied from the battery cell through the switching element and the trigger switch;
a current detector configured to detect a current value flowing in a current path that passes through the battery cell, the switching element, and the motor; and
a controller configured to turn off the switching element if the current detector detects an excessive current for a given time period or more,
wherein the controller executes a notice control for notifying an operator that the switching element is turned off before the switching element is turned off.

17. A battery pack comprising:
at least one secondary battery cell;
a control circuit configured to monitor a discharge current from the battery cell;
a connection terminal configured to be connected to a battery-driven-device; and
a switching element configured to interrupt a discharge path from the secondary battery to the connection terminal,
wherein the control circuit interrupts the switching element if the discharge current from the secondary battery exceeds an allowable discharge maximum value, and
wherein the control circuit interrupts the switching element if the discharge current from the secondary battery continuously exceeds a reference current value lower than the allowable discharge maximum value and falls below the allowable discharge maximum value for a first time period.

18. The power tool according to claim 3, wherein the battery cell group is detachably attached to a main body of the power tool as a battery pack stored in a housing.

19. The power tool according to claim 18, wherein the controller and the switching element are disposed within the battery pack.

20. The power tool according to claim 18, wherein the controller and the switching element are disposed on a main body in which the trigger switch and the motor are disposed.

21. The power tool according to claim 20, wherein
the controller is disposed within the battery pack,
the switching element is disposed on the main body side, and
the battery pack includes a connection terminal that outputs a control signal of the switching element to the main body.
